(19) United States
(12) Patent Application Publication
(10) Pub. No.: US 2026/0242000 A1
(43) Pub. Date: Aug. 20, 2026

(54) ILLUMINABLE LAMINATED SUNROOF FOR A VEHICLE, VEHICLE HAVING SUCH AN ILLUMINABLE LAMINATED SUNROOF

(71) Applicant: SAINT-GOBAIN SEKURIT FRANCE, THOUROTTE (FR)

(72) Inventors: Mathieu BERARD, AUBERVILLIERS (FR); Aurélie LEGRAND, AUBERVILLIERS (FR); Bernard NGHIEM, THOUROTTE (FR); Ljiljana DURDEVIC, AUBERVILLIERS (FR); Laurent MAILLAUD, AUBERVILLIERS (FR); Christy Valerie DE MEYER, HERZOGENRATH (DE); Florence JACQUES, COURBEVOIE (FR)

(21) Appl. No.: 19/157,200

(22) PCT Filed: Feb. 9, 2024
(86) PCT No.: PCT/EP2024/053347

§ 371 Date: Aug. 15, 2025

(30) Foreign Application Priority Data
Feb. 17, 2023 (FR) FR2301519

(51) Int. Cl. B62D 25/06; B60Q 1/26; F21V 5/00; G02B 5/02

(52) U.S. Cl. CPC B62D 25/06; B60Q 1/2653; B60Q 1/2696; F21V 5/005; G02B 5/0242

(57) ABSTRACT

An illuminable laminated sunroof for a vehicle, includes an optical insulating coating on a non-fluoropolymer transparent film within the lamination interlayer.

The present invention relates to an illuminable laminated glass roof for a vehicle, in particular a road vehicle's laminated glass roof with light-emitting diodes.

Light-emitting diodes have been used for motor vehicle glazed roofs, particularly panoramic laminated roofs illuminated by light-emitting diodes, as described in document WO2010049638. The light emitted by the diodes is introduced via the edge face into the interior glazing forming a guide, the light being extracted from the glazing by a scattering layer on the glazing.

To improve light extraction, document WO2015118279 proposes a luminous laminated vehicle roof incorporating, within the thermoplastic lamination interlayer, a fluoropolymer film having a thickness of at least 600 nm, having a refractive index n2 at 550 nm, the internal glass being a light guide having a refractive index n1, n1−n2 being at least 0.08, the fluoropolymer film then forming an optical insulator between the internal glass and a tinted element such as the exterior glass.

The present invention has sought to develop an alternative illuminable laminated sunroof for a vehicle.

To this end, the present invention relates to an illuminable laminated sunroof for a vehicle, in particular a road vehicle (automobile: car, truck, community transport: bus, etc.) or rail (trains, metros, tramway), comprising a laminated (preferably curved) glazing—transparent (at least in a clear glass (central) area)—comprising:
a first (curved) transparent sheet made of mineral glass, optionally tinted, particularly gray or green, intended to form the exterior glass, with a first main face F1 (intended to be oriented toward the outside of the vehicle), notably bare, and a second, opposing, main face F2 that is bare or coated with a functional transparent coating (in the clear glass area) and a first edge, notably transparent functional coating having a thickness of at most 1 μm or 200 nm, for a road motor vehicle and even for a car having a thickness preferably at most 4 mm, or even of at most 2.5 mm, even at most 2.2 mm—particularly 1.9 mm, 1.8 mm, 1.6 mm and 1.4 mm—and even having a thickness of at least 0.7 mm, for example having a refractive index nv of at least 1.5 in the visible range
a polymer lamination interlayer that is transparent (at least in the clear glass area) and is in adhesive contact with the bare or coated third face F3 and with the bare or coated second face F2, in particular single-layer or multilayer and even single-sheet or multi-sheet, comprising an upper intermediate layer, in adhesive contact with the second face F2 or with a functional transparent coating on the face F2 in the clear glass area, in particular a functional transparent coating having a thickness of at most 1 μm or 200 nm,
a second (curved) transparent (at least in the (central) clear glass area) sheet made of mineral glass or polymer, preferably extraclear (especially in configuration i) below), having a refractive index n1 in the visible range, with a third main face F3 and a fourth main face F4, preferably bare or even coated with a functional (transparent) coating in the clear glass area, notably having a thickness of at most 1 μm or 200 nm, which second sheet is preferably made of mineral glass, which third face F3 is oriented toward the outside of the vehicle and which fourth face F4 is oriented toward the passenger compartment, notably having a thickness of at least 0.7 mm (to favor the light guide), optionally less than that of the first glass sheet, even of at most 2.2 mm—notably 1.9 mm, 1.8 mm, 1.6 mm and 1.4 mm—or even at most 1.3 mm or at most 1 mm, the total thickness of the first and second sheets preferably being strictly less than 5 or 4 mm, even than 3.7 mm.

The laminated sunroof according to the invention comprises an optical insulating layer, having a refractive index n2 in the visible range, which optical insulating layer is transparent (at least in the (central) clear glass area) and is of submillimetric thickness Ei and at least 400 nm.

The laminated sunroof according to the invention further comprising a coated substrate which comprises:
a transparent film, made of material, preferably polymer, different from a fluoropolymer, with a front main face Fa oriented toward the face F2 and an opposing rear main face Fb, of submillimetric thickness Ef, (and an edge face,
the optical insulating layer which is an optical insulating coating, made of material, preferably polymer, comprising a matrix different from a fluoropolymer, (directly or on a transparent functional sublayer) on one of the front Fa or rear Fb faces, then referred to as the coated (or deposited) face and an edge face.

In a first configuration i), preferably the first sheet and/or the upper intermediate layer being tinted (notably in the clear glass area), the refractive index n1 is preferably at least 1.48 and at most 1.6, notably from 1.5 to 1.53 in the visible range (in particular glass sheet, preferably extraclear), the coated substrate is laminated between the second and third faces F2 and F3, and is between the upper intermediate layer and a lower intermediate layer (preferably untinted, colorless or in other words clear) having a refractive index n3 in the visible range, in adhesive contact with the third face F3 or with a functional transparent coating on the face F3 (in the clear glass area), in particular if n1> n3, n1−n3 is preferably less than 0.05.

n2 is less than n1 (and even than n3), the difference in refractive indices n1−n2 being at least 0.06 in the visible range, and better still at least one of the following values: 0.07, 0.08.

In this first configuration i), the roof may comprise a third sheet, made of mineral glass or polymer, with a fifth main face F5, a sixth main face F6 and a third edge face, in particular of refractive index n′1 of at least 1.48 and at most 1.6, in particular from 1.5 to 1.53, which third sheet is bonded with the second sheet via another lamination interlayer comprising another upper intermediate layer and/or another lower intermediate layer. The coated film (of the substrate) is then relatively far from the third sheet. However, the third sheet may be a light extraction sheet (guided between the optical insulating coating and the extraction zone), for example, scattering or textured.

In particular, the injection of light, derived from one or more light sources is, in a lower part of the roof, under the optical insulating coating (therefore toward face F4), preferably into the second sheet (via an internal wall of a hole (through-hole) in the second sheet or with injection via the edge face or via the fourth face F4, light refracted into the second sheet, as detailed below) and/or the lower lamination interlayer or into the optional third sheet or even under the third sheet (in particular via the face F6, light refracted into the third sheet). The third sheet may be locally textured or scattering and even sufficiently thick to facilitate injection into it, to guide it, for example a polymer sheet (polymethacrylate PMMA etc). The roof may comprise (for the injection of light) one or more light sources (peripheral, adjacent and/or opposite edges), notably one or more sets of diodes, optionally each set of diodes being coupled directly to the second glass sheet (notably by the edge or via the fourth face F4) or to an optical guide, for example an extracting optical fiber with a light exit zone along a coupling edge of the roof (of the second sheet).

In a second configuration j), the roof may additionally comprise a third sheet, made of mineral or organic glass, with a fifth main face F5, a sixth main face F6 and a third edge face, which third edge face has a refractive index n′1 preferably of at least 1.48 and at most 1.6, in particular from 1.5 to 1.53, which third sheet is bonded with the second sheet via another lamination interlayer comprising another upper intermediate layer and another lower intermediate layer in contact with the fifth face F5 and having a refractive index n′3 in the visible range; in particular, if n′1>n′3, n′1-n′3 is preferably less than 0.05.

The coated substrate is between the other upper and lower intermediate layers of said other lamination interlayer (in adhesive contact), at least one element being tinted from the first sheet, intermediate layer (upper, lower, additional) of the lamination interlayer, the second sheet, the other upper intermediate layer. n2 is less than n′1 (and even than n′3), the difference in refractive indices n′1−n2 being at least 0.05 in the visible range and better still at least 0.06 or 0.07 or 0.08.

In particular, in this second configuration, the injection of light is in a lower part of the roof, under the optical insulating coating, in particular in the third sheet (perforated or injection by the edge face or via the face F6, light refracted into the third sheet) and/or the other lower lamination interlayer (perforated or injection by the edge face) or even under the third sheet (addition of a locally textured or scattering film, for example a polymer film (PMMA, etc.)).

The roof may comprise (for the injection of light) one or more light sources (peripheral, adjacent and/or opposite edges), notably one or more sets of diodes, optionally each set of diodes being coupled directly to the third glass sheet (notably by the edge or via the face F6) or to an optical guide, for example an extracting optical fiber with a light exit zone along a coupling edge of the roof (of the third sheet).

The transparent film, like the optical insulating coating, are not based on fluoropolymer (defined as having a repeat unit based on fluorocarbon) which adheres poorly to the lamination interlayer or which requires a corona treatment for adhesion. According to the invention, the polymer has a non-fluorocarbon repeating unit (in its main chain) but whose secondary functions (grafts, side chains) optionally exhibit fluorocarbons.

For the transparent film, it is possible to select even ultra-thin glass (of at most 0.6 mm) and even, for the coated substrate, an all-mineral solution with a mineral (or hybrid) optical insulating coating, for example for a deposition obtained by liquid, in particular an (optical insulating coating) nanoporous silica sol-gel or even MgF₂.

The transparent film may preferably be a polymer film, rather than a glass, even ultra-thin which can break, and even the coated substrate is a solution, any polymer with a polymer film and a polymer matrix optical insulating coating, for example by liquid deposition such as printing (by inkjet). By mineral (or hybrid), the deposition is for example physical vapor phase, by sol-gel process.

Advantageously, in order to further increase the luminance:
the difference in refractive indices n1−n2 or n′1−n2 is at least 0.08 in the visible range and preferably at least one of the following values: 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35,
the thickness Ei is at least 800 nm, 900 nm, 1 μm and preferably less than or equal to one of the following values: 10 μm, 5 μm, 3 μm, 2 μm.

For a mechanical strength (in particular if low-index nanoparticles and/or porosities in the optical insulating coating) and/or depending on product availability (less easy at very low index), it may be desired to limit the difference in refractive indices n1−n2 or n′1−n2 and select at most 0.2 or at most 0.15 and preferably at least 0.10, 0.11, 0.12, in particular for n1 or n′1 from 1.5 to 1.53 (with second or third glass sheet).

The coated substrate (and optionally lower interlayer, second sheet or even other lower intermediate layer, third sheet) has a haze of at most 1°, or even 0.5° (outside the zone with light extraction means). It is preferable to avoid inclusions and pinholes.

In particular with n1 from 1.5 to 1.53 in the visible range (like a glass sheet), in particular at 600 nm and preferably from 500 nm to 750 nm and even from 380 nm to 750 nm, n2 and/or the average index n2ₘ may be less than or equal to one of the following values: 1.42, 1.41, 1.40, 1.39, 1.38, 1.37, 1.36, 1.35, 1.34, 1.33, 1.32, 1.31, 1.30, 1.29, 1.28, 1.27, 1.26, 1.25, 1.2, 1.19, 1.18, 1.16, 1.17, 1.15.

In particular, with n1 of at least 1.55 in the visible range, the refractive index n2 in the visible range, in particular at 600 nm and preferably from 500 nm to 750 nm and even from 380 nm to 750 nm, may be less than or equal to one of the following values: 1.50, 1.49, 1.48, 1.47.

The optical insulating coating can occupy at least 80%, 90%, 95% and even 100% (untrimmed) of the surface of the transparent film (deposition face), notably polymer film (and even thermoplastic).

The optical insulating coating can have good adhesion to the transparent film (substrate) according to the invention, preferably polymer (and even thermoplastic).

For example, the transparent film, preferably polymer (better still thermoplastic and even PET), has a smooth face on the deposition face side (Fa or Fb), a low surface roughness (notably Rz parameter) of at most 1 μm.

For better optical quality, the thickness Ei of the optical insulating coating varies by at most ±5%. The thickness Ei is preferably as low as possible to avoid a high material cost without degrading the optical function.

The optical insulating coating is transparent (to see the sky) but may be tinted or clear, in particular having (only) a light transmission of at least 80% or at least 90%.

The optical insulating coating preferably extends in the whole of the (central) clear glass area of the roof, its edge face being in particular under a masking frame layer (opaque ink or enamel: black, etc.) closer to the face F2 than the latter, which is a solid layer that is opaque and optionally has discontinuous opaque patterns (shaded for more transparency toward the center), described in detail below.

The optical insulating coating is preferably a continuous layer (mineral or organic or hybrid notably with low-index nanoparticles for example hollow silica) which occupies all of the clear glass area and all or part of the coated face Fa or Fb based on the extent of the film under the masking frame.

For the sake of simplicity the optical insulating coating is a monolayer but may be manufactured in one or more passes (by liquid).

The optical insulating coating may be surmounted by one functional (over) layer, in particular a protective layer: a diffusion barrier and/or mechanical protection in particular, film for example of at most 100 μm and at least 30 μm or coating for example at most 10 μm. An optical insulating coating can be selected with a matrix (organic, mineral) and low-index (or hollow and/or porous) nanoparticles, a dense overlayer (organic, mineral) of the same matrix.

Preferably, in particular in order to simplify manufacturing, on the transparent film, preferably thermoplastic or crosslinked polymer, the optical insulating coating may be organic, crosslinked polymer or thermoplastic, and the organic protective overlayer, for example thermoplastic or crosslinked polymer.

In a first embodiment, the optical insulating coating is on the rear face Fb, notably the transparent film (substrate), notably polymer and even PET, is clear or tinted.

In a second embodiment, the optical insulating coating is on the front face Fa—and the notably polymer and even PET carrier film is clear, notably is of refractive index n4 greater than n2 (and even greater than n3 and n1 or n′3 and n′1). For example, n4-n2 of at least 0.05 or even one of the following values: 0.1, 0.2, 0.3.

Since the transparent film according to the invention, preferably polymer, does not stick to glass, it is in adhesive contact with the lamination interlayer (respectively with the other lamination interlayer) which bonds the first and second sheets (respectively second and third sheets).

Thus, in one embodiment, the lamination interlayer (upper intermediate layer or optional additional intermediate layer, lower intermediate layer) or the other lamination interlayer (other upper intermediate layer, other lower intermediate layer) is in adhesive contact with the substrate coated on the front face Fa side and on the face Fb side; in particular, the adhesive contact may be over the entire surface of the face opposite the coated face (Fa) and in adhesive contact with the entire surface of the optical insulating coating. Optionally, a functional coating, notably a scattering coating-forming light extraction means—is applied to the lower thermoplastic interlayer (PVB) or the other lower thermoplastic interlayer (PVB), either locally or discontinuously (set of patterns, etc.). It may be in contact with the rear face (Fb, bare or with an underlayer) or with the optical insulating coating (on face Fb) or even in contact with face F3.

Thus, the lower intermediate layer (respectively of the other lower intermediate layer) may comprise a functional coating on the rear face side of the coated substrate or on the face F3 side, notably a scattering coating (forming a light extractor) which is preferably transparent (in the off state), notably partially covering the lower intermediate layer (respectively of the other lower intermediate layer).

And when the optical insulating coating is on the rear face Fb, the lower intermediate layer (respectively, the other lower intermediate layer) is then in adhesive contact with part of the surface of the optical insulating coating and the functional coating (scattering, notably extractor) on the rear face side Fb is then also in contact with the optical insulating coating. When the optical insulating coating is on the front face Fa, the lower intermediate layer (respectively, the other lower intermediate layer) is then in adhesive contact with part of the uncoated face Fb and the functional coating on the rear face side is then also in contact with the uncoated face Fb.

For example, this functional scattering coating (on the rear face side Fb) oriented toward face F2 and deposited on the thermoplastic lower intermediate layer (PVB) (respectively, the other thermoplastic lower intermediate layer (PVB)), forming light extraction means and preferably occupies at most 50% or 40% of the roof, or of the clear glass area, or of the lower intermediate layer (respectively of the other lower intermediate layer).

For example (in configuration i)), this functional scattering coating on the face F3 or on the face F3 side of the thermoplastic lower intermediate layer (PVB) (respectively of the other thermoplastic lower intermediate layer (PVB)), forming light extraction means and preferably occupies at most 40% or 30% of the roof, or of the clear glass area, or of the lower intermediate layer (respectively of the other lower intermediate layer).

The optical insulating coating may comprise (consist of) an organic or hybrid mineral matrix, with said index n2 preferably of at most 1.42 or 1.4 (in particular if n1 or n′1 are from 1.51 to 1.53), which insulating coating is optically clear or optionally tinted with a dye (molecular or pigment).

The optical insulating coating may comprise at least 99% by weight of crosslinked polymer, optional photoinitiators, rheological agents.

The optical insulating coating is preferably deposited by a liquid process.

The surface of the optical insulating coating (before the assembly) is non-adhesive and involving the use of the lamination interlayer. The surface is in particular no-adhesive to glass, to the touch. Depending on the chosen deposition face, the upper interlayer or lower interlayer or an additional interlayer of said lamination interlayer is in adhesive contact with said surface or the other lower or upper interlayer is in adhesive contact with said surface.

The optical insulating coating is in particular a varnish obtainable from a photocrosslinkable resin and with photoinitiators if necessary or else thermally crosslinkable, a bi-component mixture, etc. A crosslinkable resin layer is deposited on the (transparent) preferably polymer film. Once the material is crosslinked, the free surface is not adhesive.

In particular, the optical insulation coating comprises (consists of) a crosslinked polymer matrix with said index n2 preferably at most 1.42 (or 1.4 or 1.35), matrix preferably from:
polymers based on polyacrylate (for example in order to have a refractive index of at most 1.42 or 1.4) with optional fluorinated function (in order to have as low as possible a refractive index), in particular urethane acrylate or fluorourethane acrylate or fluorosilicone acrylate,
or even silicone (for example having a refractive index of at most 1.4 or 1.3), in particular polydimethylsiloxane, epoxy polymer, polyepoxides, polyurethane, polyvinyl acetate, polyester.

Preferably, the optical insulating coating is free of free silicone, of volatile silicone component (source of surface contamination).

The polyacrylate described herein refers to any polymer containing repeating units derived from acrylate. The repeating unit can be substituted or not substituted in the allowed valence range. The acrylate polymer may be homopolymer and/or copolymer. In this text, the polyacrylate comprises one or more polymethyl acrylates, polyethylene acrylate, polypropyl methacrylate, polymethyl methacrylate, polyethylene methacrylate, polyethyl methacrylate, polypropyl methacrylate.

The epoxy polymer described herein refers to the polymer obtained after polymerization of substances containing epoxy bonds. The epoxy polymer comprises one or more epoxy bisphenol A, bisphenol A epoxy, halogenated phenolic epoxy, phenolic epoxy, cycloaliphatic epoxy, bisphenol S epoxy resin.

The crosslinked polymer material (of the optical insulating coating) may preferably be based (or essentially composed of) a polymer associated with one or more functions such as the acrylate function for photo-crosslinking (crosslinked polymer material based on urethane acrylate or based on silicone acrylate) and/or the fluorinated function in order to cause the refractive index (crosslinked polymer material based on fluorourethane acrylate or fluoro-silicone acrylate) to drop. Thus, it is preferable for the crosslinked polymer material of the optical insulating coating to be a polymer, preferably based on acrylate, urethane acrylate, or even silicone, silicone acrylate, the polymer also having a fluorinated function.

Depending on the desired properties, the acrylate function can be used for photo-crosslinking (for a urethane acrylate or a silicone acrylate). The acrylate function allows the photo-crosslinking of the polymer, the backbone of the polymer consisting of other functions such as urethane.

The optical insulating coating according to the invention can in particular be a coating obtained by the liquid process and obtained from a formulation, preferably photocrosslinkable by UV (in particular UVA) or even bi-component, crosslinking by chemical reaction. UV(A) crosslinking is preferred since crosslinking is faster and the equipment is less expensive/more compact than by chemical reaction.

In a first example of an optical insulating coating, a crosslinkable UV resin based on acrylates is deposited on the notably polymer and even PET transparent film.

In a second example of an optical insulating coating, a monocomponent crosslinkable UV resin based on acrylates (urethane acrylate) is deposited on the notably polymer and even PET transparent film.

In a third example of an optical insulating coating, a crosslinkable silicone-based UV resin is deposited on the notably polymer and even PET transparent film.

The optical insulating coating (clear or tinted) may comprise, or even consists of, a matrix having a refractive index n2ₘ greater than n2 and less than n1 or n′1, and n2ₘ is preferably at most 1.48 and n2 is preferably at most 1.42, and comprising (nano) porosities and/or (nano) particles of low index, in particular hollow and/or porous with a size (outer diameter) of at most 300 nm or even of at most 100 nm, for example hollow and/or porous silica nanoparticles (spheres, etc.). Preferably, the optical insulating coating is free of free silicone, of volatile silicone component (source of surface contamination).

The matrix of the optical insulating coating may be organic, notably crosslinked or thermoplastic polymer, in particular selected from polymers based on polyacrylate, polyepoxides, polyvinyl acetate, polyester, polyurethane, PVB, or the matrix is mineral, notably silica.

The low-index polymers already described can be cited if n2 is to be further reduced by the matrix and (nano) porosities and/or (nano) particles.

The optical insulating coating comprises in particular at most 60% by volume fraction of the (nano) porosities and/or (nano) particles of low index or one of the following values: 40, 45%, 40%, 35%, 30%.

The refractive index n2 can be adjusted based on the volume of low-index or hollow nanopores or nanoparticles of low index. The following relationship can be used as a first approximation for calculating the index:

n2=f·n₂ₘ+(1−f)·n_{eff}, where f is the volume fraction of the material constituting the layer and n2ₘ is its refractive index (dense) and n_{eff} is the refractive index of the nanoporosities (equal to 1) or the effective index of the nanoparticles (hollow and/or porous or low-index).

Table 1 below illustrates the refractive index n2 as a function of n2m and of the volume fraction.

TABLE 1

| f | 1-f | n2m = 1.5 | n2m = 1.48 | n2m = 1.45 | n2m = 1.42 | n2m = 1.4 | n2m = 1.35 |
|---|---|---|---|---|---|---|---|
| 1 | 0 | 1.50 | 1.48 | 1.45 | 1.42 | 1.40 | 1.35 |
| 0.9 | 0.1 | 1.45 | 1.43 | 1.41 | 1.38 | 1.36 | 1.32 |
| 0.85 | 0.15 | 1.43 | 1.41 | 1.38 | 1.36 | 1.34 | 1.30 |
| 0.8 | 0.2 | 1.40 | 1.38 | 1.36 | 1.34 | 1.32 | 1.28 |
| 0.75 | 0.25 | 1.38 | 1.36 | 1.34 | 1.32 | 1.30 | 1.26 |
| 0.7 | 0.3 | 1.35 | 1.34 | 1.32 | 1.29 | 1.28 | 1.25 |
| 0.65 | 0.35 | 1.33 | 1.31 | 1.29 | 1.27 | 1.26 | 1.23 |
| 0.6 | 0.4 | 1.30 | 1.29 | 1.27 | 1.25 | 1.24 | 1.21 |
| 0.55 | 0.45 | 1.28 | 1.26 | 1.25 | 1.23 | 1.22 | 1.19 |
| 0.5 | 0.5 | 1.25 | 1.24 | 1.23 | 1.21 | 1.20 | 1.18 |
| 0.45 | 0.55 | 1.23 | 1.22 | 1.20 | 1.19 | 1.18 | 1.16 |
| 0.4 | 0.6 | 1.20 | 1.19 | 1.18 | 1.17 | 1.16 | 1.14 |

The mineral optical insulating coating comprises (in particular consists of) preferably:
a sol-gel layer based on porous silica and E1 is at most 1 μm, better still at most 800 nm and even 700 nm, in order to avoid the risk of cracks, n1 can readily go up to 1.3
or a layer based on oxide (silica, etc.) deposited by physical vapor deposition PVD such as magnetron sputtering, and E1 is at most 1 μm, better still at most 700 nm since the deposition is very slow.

With magnetron sputtering, the silica layer can contain one or other elements such as aluminum and the refractive index may be 1.48.

The proportion by volume of pores may be limited and controlled in particular by the sol-gel process.

It is thus possible to choose silica prepared from tetraethoxysilane (TEOS).

The pores can be closed, by removing a particulate pore-forming agent.

The structuring of the sol-gel layer in pores is linked to the sol-gel type synthesis technique, which makes it possible to condense the essentially mineral (that is, mineral or hybrid organic) material with a pore-forming agent suitably chosen in particular of size(s) and/or of well-defined shape(s) (elongated, spherical, oval, etc.).

The laminated sunroof (in particular the coated film) may comprise a protective transparent layer (film or coating), in particular polymeric (thermoplastic or crosslinked polymer), having a refractive index of greater than n2, of submillimetric thickness and even of at most 100 μm, (on and) covering the optical insulating coating, optionally protruding from the optical insulating coating. In particular, it protects the optical insulating coating comprising low index (nano) porosities and/or (nano) particles, in particular hollow, porous (silica, etc.). The protective transparent layer is a mechanical protection:
in contact with the lower intermediate layer or the other lower intermediate layer and even with a scattering functional, forming light extraction means (discontinuous or local),
or in contact with the upper intermediate layer or the other upper intermediate layer, the optical insulating coating being on the front face.

The transparent film is for example thermoplastic polymer (flexible, curved according to the curvature of the glazing).

The transparent film (substrate) notably polymer according to the invention preferably has dimensional stability, is compatible with the lamination operation (pressurized, at a given temperature), is compatible with autoclave passage.

The film (substrate) according to the invention is distinct from a lamination interlayer, bonding the sheets, it requires the use of the lamination interlayer. The film (substrate) preferably is a non-adhesive film at room temperature.

The edge face of the coated substrate (of the transparent film, and even of the optical insulating coating) may be remote from the edge face of the first sheet (or of the third sheet) by at least 10 mm and even by at least one of the following values: 15 mm, 20 mm, 25 mm, 30 mm.

The edge face of the coated substrate (of the film, of the optical insulating coating) may be remote from the clear glass area by at most 15 mm and even by at least one of the following values: 10 mm, 8 mm, 5 mm, 1 mm.

For protection, preferably, the periphery of the transparent film, notably polymer and even PET, (and even the coated substrate) can be surrounded, in (adhesive) contact, with part of the lamination interlayer (PVB, EVA, TPU, etc.), for example with a width of at least 5 mm:
or derived from the creep of the lower interlayer and/or the creep of the upper interlayer or of an additional interlayer
or by adding a peripheral frame layer with a thickness in particular greater than or equal to the thickness Ef of the transparent film.

In one embodiment, the transparent film is recessed from the first or second edge face by at least 10 mm, and even by at least 15 mm or 20 mm or 25 mm; in particular, the thickness Ef of the transparent film is at least 0.2 mm and the roof comprises an intermediate frame layer, forming part of the lamination interlayer or of the other lamination interlayer surrounding the periphery of the coated substrate and notably between faces F2 and F3 in the first configuration i) or between faces F5 and F6 in the second configuration j).

The thickness Ea of the intermediate frame layer can be similar to Ef, for example Ef±50 μm or even ±25 μm or else greater, for example if the lower intermediate layer of thickness E′ is short (same size as the film) edge to edge with the transparent film, then Ea=Ef+E′±50 μm or even ±25 μm.

The frame interlayer is in contact with the upper or additional interlayer or the other upper interlayer and optionally in contact with the lower interlayer or the other lower interlayer.

It is preferable to choose the same material (in particular PVB) for an optional upper or additional interlayer, lower interlayer.

A light source (each source if several sources) on the passenger compartment side may be associated with a light redirecting element, in particular prismatic element (reflector or transparent). The frame interlayer above this (each) light redirecting element (notably a prismatic reflective element) may be tinted or even opaque, black in particular in order to mask any parasitic light.

The frame layer may be locally opaque (on a strip) or opaque over the entire periphery.

Furthermore, this laminated glass roof is preferably curved. It thus has one or more bends, with one or more radii of curvature ranging in particular from 10 cm to 40 m. The bending may be extremely intense, in particular having a high degree of sphericity, i.e. with at least one radius of curvature of at most 0.5 m, locally.

In order to avoid wrinkles and ripples, preferably the coated substrate is in a zone of the roof having a curvature, a sphericity limited in particular by a radius of curvature of at least 1.5 m.

The thicker the transparent film is, the less likely it is to deform and to make ripples. For example, it is possible to choose a thickness of at least 100 μm in the event of a zone of the roof of high sphericity.

The coated film (of the substrate) may have a surface area of at least 1 m in length by at least 50 cm wide.

The coated film (of the substrate), notably polymer and even thermoplastic in particular PET, can occupy 100% of the clear glass area.

The film of the coated substrate notably polymer and even thermoplastic in particular PET, may occupy at least 80%, 90% and less than 100% of the surface area of the roof (in order to be protected, at the periphery notably, by a material notably a lamination interlayer).

The film of the coated substrate notably polymer may be of any shape, based on the design of the roof, with rounded corners, etc.

The transparent film may be a thermoplastic polymer or crosslinked polymer, in particular:
polyester, such as polyethylene terephthalate PET, polybutylene terephthalate PBT, polyethylene naphthalate PEN,
polycarbonate (PC),
polyacrylate, in particular thermoplastic, polybutylacrylate, polymethacrylate PMMA,
polyurethane (PU), in a crosslinked material,
cellulose triacetate (TAC),
polyolefin: polypropylene (PP), polyethylene (PE),
polyimide, polyamide, a PET-PMMA film (coextruded),
polyvinyl chloride PVC.

PET (readily available) or PEN is preferred, a polyacrylate film, or else PC (preferably PVB interlayers without plasticizers or with few plasticizers) or PMMA.

The transparent notably polymer and even PET film is preferably of thickness Ef of at least 30 μm and/or preferably less than 200 μm, in particular of at most 100 μm.

With a polymer, PC or PMMA film, it is preferred (for better chemical compatibility) as an interlayer in contact with it (lower, additional or upper or even frame), PVB is avoided and for example thermoplastic polyurethane (TPU) is preferred. The same is true for the second or third polymer sheet, PC or PMMA.

The lower (clear) and/or upper (clear or tinted) intermediate layer, preferably in sheet form, is thermoplastic or crosslinked adhesive material, preferably chosen from polymers based on: polyvinyl butyral, referred to as PVB, or ethylene-vinyl acetate copolymer, referred to as EVA (thermoplastic or crosslinked), thermoplastic polyurethane (TPU) or ionomer. An example of a monomer resin is marketed by Kuraray Company under the registered trademark SentryGlas®. The lower interlayer (clear) and/or upper interlayer (clear or tinted) made of crosslinked adhesive material is for example a polyacrylate sheet.

The intermediate layer, preferably upper, may be made of anti-UV PVB, for example PVB anti UV from Eastman, named RU41, for example to protect an electroactive layer (electrochromic, etc.) or any organic ink or coating.

The lamination interlayer (one of the lower, upper or additional interlayers) can be acoustic, in particular it can comprise or consist of an acoustic PVB (three-layer, four-layer, etc.). Thus, the lamination interlayer can comprise at least one layer, called central layer, made of viscoelastic plastic with vibro-acoustic damping properties, particularly based on polyvinyl butyral and plasticizer, and the interlayer, and further comprising two external layers made of standard PVB, with the central layer being between the two external layers. Mention may be made of the acoustic PVBs described in the patent applications WO2012/025685, WO2013/175101, in particular tinted as in WO2015079159.

The upper intermediate layer can be tinted, in particular of light transmission, referred to as LT, of at most 73%, in particular tinted PVB.

An additional intermediate layer, between the lower (clear) and upper interlayer can be tinted, notably with a TL of at most 73%, in particular tinted, or even at least 13% (for example to integrate a functional film, an electro-controllable device detailed later).

The lower (clear) intermediate layer may notably have a TL of at least 90% and better still of at least 95% or 97%.

The lower intermediate layer (in particular PVB or even crosslinked polymeric adhesive material) may be of the same size as the coated substrate (a framing layer is optionally necessary depending on the thickness of the coated substrate, in particular from 100 or 200 μm) or more extensive than the coated substrate. The upper or additional interlayer or a frame interlayer can creep to protect the edges of the coated substrate.

The frame interlayer, preferably thermoplastic and even PVB-based (with or without plasticizers) may be one or more sheets depending on the desired thickness and/or tinted (clear and/or tinted or even opaque sheet).

The tinted interlayer which is in whole or in part in the clear glass area is preferably gray.

The tinted frame interlayer outside the clear glass area may be gray, black (opaque or quasi-opaque), preferably thermoplastic and even PVB-based (with or without plasticizers) notably the frame layer.

It is possible to provide, for the lamination interlayer (respectively, the other lamination interlayer), an “all PVB” solution in sheets, or a solution with PVB except for the lower intermediate layer made of a crosslinked adhesive material film or coating from a crosslinkable adhesive liquid resin, in particular when the second sheet is made of glass (respectively, the third glass sheet) or polymer (PC, PMMA), in particular having an index n3 (or n′3) of greater than 1.42.

For this lower intermediate layer, mention may be made, as crosslinkable adhesive liquid resin (referred to as LOCA), of the acrylate-based adhesive resin, for example in particular the product named UZ181A (refractive index 1.47) from AKChemTeck.

In another example of lower intermediate layer in the form of a crosslinked polymeric adhesive coating, a crosslinkable ultraviolet (UV) resin based on mercapto ester is deposited: the product NOA 65 from Norland having a refractive index equal to 1.524.

In another example of a crosslinked polymeric adhesive layer in the form of a crosslinked polymeric adhesive coating, a single-component UV-crosslinkable resin based on polyfluorene having acrylate functions is deposited: the product referred to as Shin-A SBPF-022 having a refractive index equal to 1.60.

The lower intermediate layer may comprise or even be a crosslinked polymer film in particular of at least 30 μm or 40 μm or 50 μm.

In particular, the lower interlayer is a Pressure Sensitive Adhesive (PSA), bonds by contact after application of a mechanical pressure.

In particular, the lower intermediate layer made of crosslinked polymer is a crosslinked polymer film in particular of at least 30 μm, which is preferably in adhesive contact with the third face F3 and most particularly:
pressure-sensitive film, and preferably chosen from acrylate, or silicone-based polymers
or a partially photocrosslinked polymer post-adhesive film before assembly and photocrosslinked (with continued photocrosslinking) after assembly, and preferably a so-called acrylate post-adhesive film.

As an acrylate-based PSA film, mention may be made of the product CS986 (refractive index 1.49) from Nitto.

In the first configuration i), the lower lamination intermediate layer is in particular clear, notably thermoplastic and/or crosslinked adhesive material, preferably selected from: EVA, TPU, PVB with at least 20% by weight of plasticizers, preferably having a thickness of at least 200 μm and at most 1 mm, PVB or less than 20% by weight of plasticizers or without plasticizers, preferably of at most 100 μm and in particular having a thickness of at least 25 μm, and the second sheet is made of extra-clear glass or PMMA or polycarbonate (PC).

In the second configuration j), the other lower intermediate layer is in particular clear and thermoplastic selected from: EVA, TPU, PVB with plasticizers having a thickness of at most 380 μm, PVB or with little plasticizers or without plasticizers having a thickness of at most 100 μm or 50 μm and even of at least 20 μm, and the third sheet is made of extra-clear mineral glass or PMMA or PC.

The laminated glass roof according to the invention may include one of the following sequences (strict or open):
first glass sheet (tinted or clear with electrically conductive coating, infrared (IR)-reflecting coating, etc. on face F2)/thermoplastic upper intermediate layer (PVB, TPU or EVA)/coated substrate/thermoplastic lower (clear) intermediate layer (PVB, TPU or EVA) or adhesive crosslinked polymer material (EVA, adhesive polyacrylate, etc.)/second glass sheet (extraclear)
first glass sheet (tinted or clear with electrically conductive coating, IR-reflecting on face F2)/thermoplastic upper intermediate layer (PVB, TPU or EVA)/coated substrate/thermoplastic lower (clear) intermediate layer (preferably TPU or EVA) or adhesive crosslinked polymer material (EVA, adhesive polyacrylate, etc.)/second polymer sheet (PMMA, PC)
first glass sheet (tinted or clear with electrically conductive coating, IR-reflecting on face F2)/thermoplastic upper lamination interlayer (PVB, TPU or EVA)/coated substrate/thermoplastic lower (clear) intermediate layer (PVB, TPU or EVA) or adhesive crosslinked polymer material (EVA, adhesive polyacrylate, etc.)/second glass sheet/other lamination interlayer/third glass or polymer sheet
first glass sheet (tinted or clear with electrically conductive coating, IR-reflecting on face F2)/thermoplastic upper intermediate layer (PVB, TPU or EVA) or adhesive crosslinked polymer material (EVA, adhesive polyacrylate, etc.)/second glass or polymer sheet (PMMA, PC)/other thermoplastic upper intermediate layer (PVB, TPU or EVA) or adhesive crosslinked polymer material (EVA, adhesive polyacrylate, etc.)/coated substrate/other thermoplastic lower (clear) intermediate layer (PVB, TPU or EVA) or adhesive crosslinked polymer material (EVA, adhesive polyacrylate, etc.)/third glass sheet (extraclear).

For example, preferably:
first glass sheet (tinted or clear with electrically conductive coating, IR-reflecting on face F2)/thermoplastic PVB upper intermediate layer (clear or tinted)/coated substrate/thermoplastic PVB lower (clear) intermediate layer or adhesive crosslinked polymer material (EVA, adhesive polyacrylate, etc.) with optional functional (scattering) coating on rear face or face F3/second glass sheet (extraclear)
first glass sheet (tinted or clear with electrically conductive coating, IR-reflecting on face F2)/thermoplastic PVB upper intermediate layer/coated substrate/thermoplastic lower intermediate layer (preferably TPU or EVA) or adhesive crosslinked polymer material (EVA, adhesive polyacrylate, etc.)/second polymer sheet (PMMA, PC).
first glass sheet (tinted or clear with electrically conductive coating, IR-reflecting on face F2)/thermoplastic PVB upper intermediate layer or adhesive crosslinked polymer material (EVA)/second glass sheet/other thermoplastic upper intermediate layer (PVB, TPU or EVA) or adhesive crosslinked polymer material (EVA, adhesive polyacrylate, etc.)/coated substrate/other thermoplastic lower intermediate layer (PVB, TPU or EVA) or adhesive crosslinked polymer material (EVA, adhesive polyacrylate, etc.)/third glass sheet (extraclear).

Of course, the laminated sunroof may comprise a light source optically coupled to a light guide arranged under the optical insulating coating (farther from face F2 than the optical insulating coating), and preferably light extraction means for extracting light guided in the light guide, which are on the third face F3, or face F4, side in configuration i) or on the fifth face F5, or face F6, side in the second configuration j).

When the extraction (light) means are a scattering coating (printed ink) on a PVB intermediate layer or on the coated substrate rather than on the second (or third) glass sheet, it is easier to change the extraction and tooling pattern for printing on a flat film than on bent glass. For mechanical strength and above all to retain the pieces of glass, it is better also to have the extraction on the coated or PVB substrate than on glass.

The (each) light source can be removable, added, sold separately or in a kit.

The extraction means may be provisional (detachable stickers) and therefore added or replaced, in particular on the fourth face (respectively face F6) side, or may be permanent, in particular on the third face (respectively face F5) side.

Of course, the second sheet (respectively the third sheet) can be an operational light guide once the (each) light source and extraction means have been mounted.

The (each) light source is preferably a set of light-emitting diodes (on a printed circuit support such as a PCB—for printed circuit board—for example a flexible PCB), in particular a straight or curved strip.

Preferably, the diodes are components that are surface mounted on the front face of a printed circuit board called PCB board (with conductive tracks). The width (or length) of a diode with a single semiconductor chip, generally a square diode, is preferably at most 5 mm. The width of the PCB board, preferably in strip form, is preferably at most 5 cm, better still at most 2 cm and even at most 1 cm.

It is possible to have one or more light sources (peripheral, preferably offset from the clear glass area), several sets of diodes. The light source(s) may be monochromatic (emitting in the blue, green, red, etc.) or polychromatic, or be adapted or combined to produce, for example, white light, etc.; they may be continuous or discontinuous, etc. The light source may be linearly extended (rectangular strip like a diode array) along one side of the glazing (longitudinal edges) or duplicated (with similar or different light, for example a different color intensity, controlled independently or simultaneously) along both sides.

The light extraction means may define at least one first scattering zone, for example having a width of at least 0.5 mm, in particular a first solid scattering zone and/or comprising a set of discontinuous scattering patterns.

The roof may comprise a plurality of scattering zones having identical or different sizes and/or shapes. The extraction zone may cover part or all of the laminated glazed unit depending on the lighting or the desired effect (in the form of strips disposed on the periphery of one of the faces in order to form a luminous frame, logos or designs, etc.).

The scattering zone may be in a plurality of zones, for example each with identical or different, continuous or discontinuous designs, and can be any geometrical shape (rectangular, square, triangular, circular, oval, etc.), and can form a drawing, a sign (arrow, letter, etc.).

In one embodiment, the light extraction means can comprise an extractor film between the optical insulating coating and the third face F3, (respectively the fifth face F5) preferably on the third face (respectively the fifth face F5) or the fourth face F4 (respectively the face F6) in the first configuration i) (respectively the second configuration j).

This extractor film may be adhesively bonded to the rear face Fb of the coated substrate and may be reflective.

An example of a film having reflective reliefs, in particular of a plastic film having a refractive index greater than or equal to n1 with reflective reliefs (prisms) forming light extraction on the third face of a car roof is described in patent WO2013/167832.

Polymer films textured by a relief are commercially available, and mention may for example be made of the film Vikuiti® Image Directing Film II sold by 3M.

It is also possible to form a silica-based mineral or organomineral coating with the reliefs, by the sol-gel route.

An extractor film may comprise a plurality of individual prisms, each consisting of an oblique surface and a surface that is essentially perpendicular to the general plane of the second sheet (respectively of the third sheet).

An example of regular relief that can be mentioned is a relief of the Fresnel lens type or a relief of the Fresnel prism type.

The extractor film may have a customized extent. It may be local or cover at least 50%, 60%, 70%, of the clear glass area. The extractor film may have one or more extraction zones that are local (textured, etc.) or occupy at least 50%, 60%, 70%, of the clear glass area (and/or at least 50%, 60%, 70% of the surface of the transparent film). The extractor film may be smaller than the lower intermediate layer and/or than the transparent film.

The light extraction means can be a frosted zone of the second glass sheet (respectively of the third glass sheet) or at least one zone etched in the thickness of the second glass sheet (respectively of the third glass sheet) or else scattering elements, such as glass particles or fibers, incorporated in the lamination interlayer or the other lamination interlayer.

To sum up, under the optical insulating coating (farther from the face F2 than the insulating coating), light extraction means for extracting light guided in the light guide, are for example in the form of:
laser etching in the (mineral) guide, in particular second sheet or third glass sheet,
texturing (acid etching of the glass, etc.), textured film
or a scattering coating or film, preferably transparent, with a binder and scattering particles, which binder (organic, mineral or hybrid) is transparent and preferably has a refractive index n5 greater than or equal to n1 or n3 or to n′1 and n′3, in particular of at least 1.48.

The binder may be a transparent ink.

Preferably, the assembly of scattering coating and the substrate thereof (second sheet, third sheet, lower interlayer) has a light transmission of at least 80% and a haze of at most 30%.

In particular, the roof comprises, under the optical insulating coating, light extraction means, comprising a scattering coating, preferably transparent, with a binder and scattering particles, which binder preferably has a refractive index n5 greater than or equal to n1 (or even to n3) or to n′1 (or even to n′3), in particular of at least 1.48.
in the first configuration i), the thermoplastic (PVB) lower intermediate layer or the second sheet is the substrate of the scattering coating (thus on the face F4 or F3, or on the rear face Fb side), in particular optionally in contact with the optical insulating coating on the rear face Fb
in the second configuration j), the other thermoplastic (PVB) lower intermediate layer or the third sheet is the substrate of the scattering coating (thus on the face F5 or F6, or on the rear face Fb side), in particular optionally in contact with the optical insulating coating on the rear face Fb.

For example, the binder of the scattering coating is organic, in particular crosslinked polymer, selected from polymer based on polyacrylate, polyepoxides, polyvinyl acetate, polyester, polyurethane, or else thermoplastic based on PVB, or even TPU.

The lower intermediate layer may be PVB-based, comprises from 70% to 75% by weight of PVB, 25 to 30% by weight of plasticizer and less than 1% by weight of adjuvants. There are also PVB sheets with few plasticizers (less than 10% or 5% by weight of plasticizers) or no plasticizer such as the “MOWITAL LP BF” film from KURARAY.

When the substrate of the scattering coating is the lower intermediate layer, it is selected to be based on PVB without plasticizers or at most 15% or 10% or 5% of plasticizers. For example, the thickness of the lower intermediate layer forming a substrate is at most 200 μm.

Document WO2021005162 contains an example of a scattering coating on a polymer layer, in particular a lamination interlayer and based on PVB.

Document WO2023285743 contains an example of a scattering coating on a PVB or glass lamination intermediate layer.

For example, the binder of the scattering coating is a polyacrylate polymer and the binder of the optical insulating coating is a polyacrylate polymer, in particular a polyacrylate with a fluorine function and/or with low-index nanoparticles or nanoporosities and/or hollows, notably if the coatings come into contact after lamination.

Preferably, the scattering particles (dielectric, organic or mineral, for example metal oxides) have a particle size defined by D90 of less than 2 μm, preferably of at least 100 nm and even of at most 700 nm, in particular 400 nm±100 nm.

Preferably, the scattering particles are selected from among non-luminescent particles of TiO₂, SiO₂, CaCO₃, ZnO, Al₂O₃, ZrO₂. Preferably, the particles have a (high) refractive index, greater than or equal to 1.8 or even 2 (greater than n5, in particular at most 1.8 or 1.7).

Preferably, for the manufacture of the scattering coating, an ultraviolet-curable resin is selected from a reaction product between a thiol and an alkene (referred to as a thiol-ene), an acrylate such as epoxy-acrylate, polyester-acrylate, urethane-acrylate, silicone-acrylate, alone or as a mixture of several thereof.

The thickness of the scattering coating is at most 100 μm, preferably at most 50 μm, and in particular at least 5 μm or 10 μm. The minima may depend on the deposition method.

A small thickness makes it possible to reduce the material cost, but the thickness can be varied in order to modify the visibility/luminance compromise of the pattern.

Preferably, the refractive index of any layer according to the invention is defined for a reference value in a range extending from 550 to 630 nm, preferably to 600 nm. Preferably, the difference in refractive indices n1−n2 or n′1−n2 is verified for the entire visible spectral range of the light source.

A polymer layer according to the invention (optical insulating coating, scattering coating, adhesive interlayer, etc.) can contain at least 80%, 90%, 95% or 99% by weight of polymer(s) and even at most 20%, 10%, 5%, 2%, 1% of additives.

A crosslinked polymer layer (optical insulating coating, scattering coating, adhesive interlayer) according to the invention may contain a main polymer (or base polymer) at least 50%, 60%, 70%, 80%, 90%, 95% by weight of polymer(s).

A crosslinked polymer layer according to the invention may comprise other additives (preferably less than 10% or 5% or 1% by weight of layer) such as at least one of the following:
crosslinking agent for example photoinitiators (residual),
plasticizers (for greater flexibility)
adhesion promoters
additives for durability.

The degree of polymerization or even crosslinking of a crosslinked polymer layer according to the invention is not necessarily 100%; the material can therefore comprise residual prepolymers, monomers, oligomers. NMR (Nuclear Magnetic Resonance) can be used to analyze the layer after crosslinking in order to determine the degree of polymerization. It is possible to have a mixture of polymers.

In one embodiment, in first configuration i), the roof may comprise a light source, preferably a set of light-emitting diodes, which is optically coupled with the second preferably mineral sheet of glass, notably forming an optical guide:
by a light-redirecting element, -local-, which light-redirecting element is reflective and is on the third main face F3 side or which light-redirecting element is transparent and is on the fourth main face F4 side.
by all or part of the second edge face,
or by a wall of a hole (through-thickness, closed) of the second sheet (or several walls of several holes), in particular hole offset from a clear glass area, facing an internal masking layer.

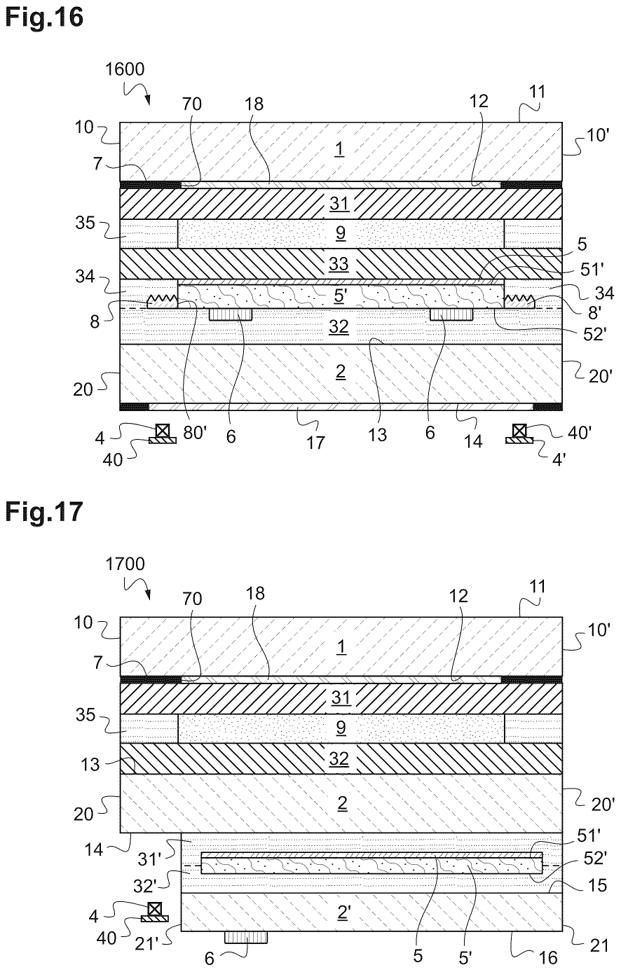

In the case of injection of light through the second edge face, the light source is coupled to the edge face of the second sheet optionally in an emerging peripheral notch. The light source may be housed in a polymer encapsulation, as described in application WO2010049638 in particular in FIG. 15 or in FIG. 16 and even having a recess for removal, replacement of the source.

In the case of injection of light via an internal wall of a hole, the second sheet, in particular made of mineral glass, comprises at least one peripheral hole (passing through the thickness or even a blind hole in the thickness, open on the fourth face F4 at least) under an internal masking layer (outside of the clear glass area) and the light source is coupled to the wall of the second sheet delimiting the hole, preferably housed in the hole. The light source, in particular the diodes, may be in the hole, may be associated with an optical element (light guide) between the injection wall and the light source in the hole or inside the passenger compartment. Mention may in particular be made of the exemplary embodiments described in patents WO2018/178591 or WO2013/110885.

Alternatively, in the second configuration j), the light source, preferably a set of light-emitting diodes, is optically coupled to the third sheet by all or part of the third edge face, referred to as “injection edge face”, optionally with a notch housing the source or preferably the injection edge face (longitudinal or lateral,) recessed by at least 10 mm and at most 200 mm from the second edge face, thus leaving a zone that “protrudes” from the second sheet, the light source being under or even attached to the protruding zone.

In the case of injection of light by offsetting the (each) light source on the passenger compartment side (on face F4 side or even face F6 in configuration j)), preferably the or each peripheral light redirecting element (preferably prismatic) is:
reflective and third face F3 side in particular prismatic, comprising reflective prisms oriented in particular toward the third face F3 or toward the second face F2
or transparent on the fourth main face F4 notably comprising a macroprism or transparent prisms, preferably prism(s) facing the passenger compartment.

The (each) light source is then facing or offset from the fourth main face F4 (or F6 in configuration j)), in particular direct optical coupling or by means of an optical system, in particular light source and light redirecting element offset from a clear glass area, facing an internal masking layer.

It is possible to have an optical element (collimator, etc.) between the (each) light source and the fourth face F4 (or F6 in configuration j)), notably an optical element attached to the fourth face F4 (or F6 in configuration j). The light source may be attached to the fourth face F4 (or F6 in configuration j)). The main direction of the light source radiation (before or after collimation) may be adjusted.

In particular, the sunroof comprises, in the first configuration i) (respectively configuration j)), a light source, preferably a set of light-emitting diodes, on the fourth face F4 (respectively face F6 side), and a light redirecting element (local, peripheral), which is preferably a reflective prismatic element, on the third face F3 side (respectively on the face F5 side), comprising reflective prisms oriented in particular toward the third face F3 or toward the second face F2 (respectively oriented toward the face F5 or toward the face F6) or which is preferably a transparent prismatic element on the fourth main face F4 side (respectively face F6). The redirected light propagates between the fourth face F4 and the optical insulating coating.

The light redirecting element on the third face F3 side (in the first configuration i)) is notably in contact with the lamination interlayer, in particular a reflective prismatic polymer film.

Preferably, so as not to generate parasitic light escaping toward the second face F2 and scattering (the internal edge of) the peripheral light-redirecting in particular prismatic element, and even a reflective or transparent prismatic polymer film, is:
at least partially facing the optical insulating coating
or at most 4 mm, preferably at most 1 mm, away from the optical insulating coating.

Preferably (in the first configuration i)), the reflective light-redirecting element, in particular the reflective prismatic element, is preferably at most 30 μm above the coated face or in the plane of the coated face or closer to the third face F3.

The base or the top of the prisms of the reflective prismatic element, in particular reflective prismatic film, is preferably at most 30 μm above the coated face or in the plane of the coated face or closer to the third face F3.

The reflective light redirecting element may comprise a (textured) prismatic film (with a smooth (non-textured, non-functional) main surface and an opposite textured, functional surface) that is flexible therefore curved conforming to the curvature of the laminated glazing. In particular:
a partially structured transparent polymer film forming (micro) prisms- and with a reflective coating (metallic, silver, aluminum) forming a conformal deposition-
or a transparent (flat) polymer film, forming a substrate, with on a main surface a transparent layer (polymer) with an arrangement of (micro) prisms and with a reflective coating forming a conformal deposition-.

The (reflective) (micro) prisms are oriented toward the third face F3 or toward the second face F2 (in the first configuration i)). The one reflective coating is thus oriented toward the third face F3 or toward the second face F2.

The reflective light redirecting element (comprising a textured, notably polymer, prismatic film or a substrate film, notably polymer and a textured, prismatic layer, as well as a reflective coating) can be bonded to the third face F3 directly or via at least one adhesive or held by suction (strong interaction), notably by the pressure of the assembly (in the first configuration i)). The reflective light redirecting element is for example placed on the third face and after suction of the air, there is a suction cup effect.

The prisms may have a height of at least 1 μm and preferably of at most 100 or 50 μm or 30 μm.

The notably prismatic polymer film or substrate of the microprisms (prismatic, organic layer for example) can be less than 200 μm, 100 μm, 80 μm or 50 μm and even at least 30 μm. If the film is oriented (reflective prisms) toward the third face F3, the substrate film can be tinted and even opaque or opacified. For example, PET with reflective microprisms is tinted and even opaque black.

Preferably, the prismatic film has a total thickness of at most 500 μm or even 400 μm or 200 μm or 100 μm.

In particular, the light-redirecting element is a reflective prismatic element, comprising reflective prisms, arranged on the third main face F3 side, is:
on the third face F3, in particular in contact with the lower intermediate layer or a (clear) intermediate frame layer-particularly if the intermediate layer is the same size as the coated substrate
in the lamination interlayer, in particular based on PVB:
embedded in the lower interlayer, in particular based on PVB (with or without plasticizers) or in a (clear) frame interlayer on the periphery of the coated film, in particular based on PVB (with or without plasticizers)
on the lower interlayer, between lower interlayer, in particular based on PVB (with or without plasticizers), and an upper interlayer (preferably with plasticizers) clear or tinted or a frame interlayer on the perimeter of the clear, tinted and even opaque coated film, in particular based on PVB (with or without plasticizers)
on the front face Fa, in particular in contact with the upper interlayer or an additional interlayer, or rear Fb, in particular in contact with the lower interlayer the reflective prisms being on the second face F2 side or on the third face F3 side.

Preferably, the redirecting prismatic element (notably comprising a polymer film and prisms) has a width (preferably less than the width of a masking layer) of at most 10 cm or at most 5 cm or even at most 2 cm and better still at least 1 cm and in particular has a length similar to that of the light source, linear (customized). It may be a rectangular strip with rounded corners for example.

The microprisms (provided with the reflective coating) act in particular as reflective prisms and reflect the light which strikes them in a direction which depends on the angle of inclination of the surfaces of the prism and on the angle of incidence of the light.

For example, a prismatic film comprises a thermoplastic (polymer) transparent film for example based on polyethylene terephthalate (PET), on which the transparent prisms are formed from a polyacrylate (resin crosslinked for example by UV). A partially textured layer is preferred. For the prismatic reflective film, a metal layer (conformal deposition) is added for example silver or aluminum.

The transparent prismatic film preferably has a light transmission of at least 70%, more preferentially of at least 80%, very preferentially of at least 90%.

The microprisms have for example a triangular section. For example, the prisms are contiguous.

For example, the total thickness of the reflective prismatic film is at most 500 μm (notably at least 30 or 50 μm) and even at most the thickness of the lower intermediate layer and/or of the coated film (of the substrate).

The (each) light source on the fourth face side may be associated with a collimating optics. The light source with an optional collimator can be attached on the fourth face, by direct bonding or by being spaced apart and on a peripheral support attached to the fourth face.

The frame intermediate layer, notably opaque, may cover the light redirecting element (prismatic reflective film).

The optional interior peripheral masking layer (on face F4) may comprise a gap in order not to block the optical coupling, notably to allow the rays from the light source to pass toward the notably prismatic and even reflective light-redirecting element.

This redirecting (transparent) film is for example of longitudinal shape, in particular rounded at the corners, for example of the length of the clear glass area. This redirecting film may have a thickness of at most 0.5 mm or 0.4 mm and in particular of at least 50 μm, 100 μm.

The (each) light source and the or each light redirecting element notably prismatic and even reflective may be offset from a clear glass area, facing an internal masking layer. The redirecting element (notably prismatic redirecting film) and/or the light source is for example at most 100 mm from the clear glass area and/or preferably at least 10 or 20 mm.

The edge face of the notably prismatic and even reflective light-redirecting element may be remote from the edge face of the first sheet (or of the third sheet) by at least 10 mm and even by at least one of the following values: 15 mm, 20 mm, 25 m, 30 mm.

The internal masking layer is not necessarily sufficiently opaque to not see parasitic light, the light source on the fourth face F4 side. It is possible to desire an internal, peripheral, opaque element between the second and third face, in particular between this internal masking layer (delimiting the clear glass area) and the third face or even replacing this internal masking layer.

The internal opaque element masks the light source (the light spots of the source) which is on the fourth face (F4) side or even masks the light-redirecting element (notably prismatic and even reflective element, redirecting optical film) facing the light source.

An internal opaque element of color identical or similar to the opaque internal masking layer (optional), in particular black, is preferred.

This internal opaque element, preferably black, and preferably under the black internal masking layer, is chosen from:
a part within the interlayer (black, with black coating, metal part, polymer, etc.)
in particular a film, in particular polymer (non-stick) inserted within the interlayer, in particular tinted film (thermoplastic film) that is opaque in the bulk or having an opaque layer, for example placed on or adhesively bonded to the peripheral part of the transparent film
in particular an opaque layer, for example on peripheral part of the transparent film (of the coated substrate)
or intermediate layer, notably thermoplastic, such as PVB (area—outside of the clear glass area—of the lower or additional or frame or upper intermediate layer, locally opaque or over the entire perimeter).

The internal opaque element can extend upstream from the injection zone (from the external edge of the light-directing element, notably prismatic and even reflective element) to the edge face or at least 1 cm or 5 mm from the edge face of the glazing.

This internal opaque element may preferably have a light transmission of less than 5%, more preferably still of less than 2%, 1% or 0.5% or even zero.

An example of opaque PVB comprising black pigments is the product called RB17830000 Vanceva absolute black® sold by Saflex.

The roof may incorporate one or more functional (non-adhesive) elements above the coated substrate, in particular:
electronic device (to a greater or lesser extent) chosen from at least one of the following devices: sensors; electrically controllable device having variable tint and/or scattering, additional diodes (emitting toward the first or second sheet), in particular local or extending over virtually the whole of the glazing, in particular facing or offset from the propagation zone, light extraction means between the second face and the optical insulating coating.
functional polymer film, for example infrared-reflecting film (solar control, silver stack, as a replacement for a layer on face F2), and/or heating, for example a polymer substrate with an electroconductive (transparent) coating, notably having a thickness of at most 0.4 or 0.2 mm, notably local or preferably extending over virtually the whole of the glazing (and over the entire clear glass area), with the electroconductive coating on the face F2 side or the face F3 side.

In particular, for a functional element (polymer film, electronic device, etc.) having a thickness of at least 0.2 mm, a peripheral intermediate sheet of the same nature as the two sheets, in particular based on PVB (or a thermally-crosslinked adhesive, for example a pressure-sensitive adhesive), surrounds and touches the edge face of the functional element and is between these two sheets, protruding and in contact therewith. This peripheral intermediate sheet forms part of the lamination interlayer. For a functional element having a thickness of less than or equal to 0.2 mm, the thermoplastic material can creep sufficiently.

Preferably, for any functional element (in particular polymer film) according to the invention, a thickness of at least 30 or 40 μm or 50 μm is preferred for easy handling during assembly, and preferably at most 400 μm or 300 μm.

In particular, a functional element (polymer film, electronic device) with a thickness of at most 0.2 mm does not require a peripheral intermediate sheet.

Use may be made, for the functional polymer film, for example, of a clear PET film coated with an electrically conductive layer, for example XIR from Eastman, a coextruded PET-PMMA film, for example of the SRF 3M® type.

Thus, the roof may include between the upper interlayer and the lower interlayer, above said optical insulating coating, at least one of the following functional elements:
an electrically controllable device, in particular having variable scattering (based on liquid crystals) or variable tint (based on electrochromism), comprising an electroactive layer (liquid crystals in a polymer matrix or electrochromic layer) between an electrically conductive support before the second face F2 side and a rear electrically conductive support on the third face F3 side,
a photovoltaic device; with one or more photovoltaic cells connected (in one or more rows)
or a functional film
and preferably, in particular in the first configuration i), the lamination interlayer comprises an additional intermediate layer, the coated substrate being sandwiched between the additional intermediate layer and the lower intermediate layer and the functional element between the upper intermediate layer and the additional intermediate layer.

The additional (so-called “short”) layer may be of the same size as the functional element.

A frame interlayer, in particular based on PVB (with or without plasticizers), mono- or multi-layer (sheets), clear or tinted and even opaque in mass or with an opaque ink, can serve as:
the functional element
the functional element and the additional layer (“short”)
the functional element, the additional layer (“short”) and the coated substrate (in particular of at least 200 μm)
the functional element, the additional layer (“short”), the coated substrate and the (short) lamination intermediate layer of the same size as the coated substrate.

Examples of electro-optical functional elements are the SPD functional elements (SPD=Suspended Particle Device), known for example from EP0876608B1 and WO2011033313A1, and the PDLC functional elements (PDLC=Polymer Dispersed Liquid Crystal), known for example from DE102008026339A1. There are also electrochromic functional elements known for example from EP3702572A1 or EP2917159A1.

As a general rule, the two electrodes are arranged between two carrier films, generally made of PET. Commercially available multilayer films are also covered on both sides with a protective film made of polypropylene or polyethylene, which serves to protect the carrier films from dirt or scratches.

In a particularly preferred embodiment, the functional element is a PDLC functional element (polymer dispersed liquid crystals). The functional PDLC element contains liquid crystals that are incorporated into a polymer matrix. If no voltage is applied to the PDLC functional element, the liquid crystals are aligned in disarray, which leads to a strong diffusion of the light passing through the active layer (translucency). If voltage is applied to the functional element, the liquid crystals align in a common direction and the transmission of light through the functional element is increased (transparency). However, it may also be that the liquid crystals are ordered in an unrestrained state, and the liquid crystals are disordered accordingly when a voltage is applied. However, other functional elements can also be used, for which the variability of the optical properties is based on liquid crystals, such as the PNLC (polymer networked liquid crystal). If, in relation to the functional element as the PDLC functional element, the application of a voltage is referred to, then an alternating voltage (the effective value of the alternating voltage and not the instantaneous voltage) is intended for the purposes of the invention.

For example, the haze in the scattering state of the roof with a PDLC layer is at least 80% and better still 85%, 90%, 95%.

In another preferred embodiment, the functional element is an SPD (suspended particles device) element. The SPD element contains suspended particles. The suspended particles modify the optical state of the functional element in absorbing the light by applying a voltage. The functional SPD elements therefore have switching states with transparent and opaque optical properties as well as intermediate steps between transparency and opacity. When referring to the application of a voltage in relation to the functional element as SPD element, an alternating voltage (the effective value of the AC voltage and not the instantaneous voltage) is intended for the purposes of the invention.

In another preferred embodiment, the functional element is an electrochromic functional element. In this case, the transmission of visible light through the functional element depends on the degree of ion placement. The ions are released, for example, by an ion storage layer and stored in an electrochromic layer. The transmission can be influenced by the voltage applied to the functional element, which causes ion migration. The appropriate electrochromic layers preferably contain at least tungsten oxide or vanadium oxide. If the functional element is an electrochromic functional element, the control unit is preferably not equipped with inverter and a DC voltage is applied to the functional element. A DC/DC converter for reaching voltages of between 1 V and 50 V and preferably 10 V to 42 V, but may be part of the control unit depending on requirements.

The edge face of the functional element (PDLC, EC, solar, functional film) may be remote from the edge face of the first sheet (or of the third sheet) by at least 10 mm and even by at least one of the following values: 15 mm, 20 mm, 25 mm, 30 mm.

The edge face of the functional element and that of the coated substrate can be aligned or remote by at most 10 cm or 5 cm or 1 cm.

The glazing may therefore comprise, between the second face (in particular F2) and the third face (in particular F3), an internal, opaque peripheral masking layer, in particular an enamel (black, etc.) on the second face or a coating on the lamination interlayer (upper intermediate layer), for example an opaque coating (based on PVB and with a dye) on a main face of a PVB on the second or third face side.

The internal masking layer can be 2 mm or 3 mm (less than 5 mm) from the edge face of the glazing, or can even go up to the edge face. The masking layer can be a band framing the glazing (windscreen, roof, etc.) particularly in black. Opacifying is carried out over the entire periphery to conceal bodywork elements or seals or to protect an adhesive for mounting on the vehicle. This internal masking layer in particular is in contact with the second main face. This internal masking layer delimits in particular the clear glass area. It may be advantageous for the external edge of the optical insulating coating or more broadly any adhesive layer of the lamination interlayer to be masked by the internal masking layer, not in the clear glass area. It may be advantageous for the external and even internal edges of the frame layer or are masked by the internal masking layer, not in the clear glass area, that the frame layer be under the internal masking layer.

The width of the internal masking layer along the sides of a motor vehicle roof is generally less than that at the front or even at the rear.

In particular, another masking layer, referred to as interior masking layer, can be on face F4 on the passenger compartment side, in particular facing toward the internal masking layer (and even of identical nature, for example an enamel, particularly a black enamel, on the second sheet made of mineral glass). It may be adjacent to an optional transparent functional coating, in particular athermal, at least in the clear glass area.

In particular for an automobile roof (first sheet is the exterior glazing):
the width of the internal (and even interior) masking layer along the longitudinal edges can be at most 30 cm, in particular 10-20 cm.
the width of the internal (and even interior) masking layer along the rear lateral edge can be at most 40 cm or 30 cm, in particular at least 1 or 5 cm, and along the front lateral edge at most 60 cm or 40 cm, in particular at least 1 or 5 cm.

The width of the internal masking layer is preferably greater than that of the interior masking layer. The interior masking layer is in particular congruent or of a width smaller than the width of the internal masking layer.

The internal and/or interior masking layer may be an organic or mineral binder (sintered glass frit) with an organic or inorganic coloring agent, in particular molecular dye or inorganic pigment.

The internal and/or interior opaque masking layer is preferably a continuous layer (flattened with a solid edge or alternatively a gradient edge (set of patterns).

Thus, the laminated glass roof may comprise at least one of the following functional elements:
an internal opaque peripheral masking layer, between the second face F2 and the third face F3, and even covering the periphery of the optical insulating coating and even of the coated substrate, in particular in contact with the second main face F2, defining a clear glass area
an interior opaque peripheral masking layer on the fourth main face F4 or the face F6, in particular congruent with or narrower than the width of the internal masking layer,
an internal opaque peripheral element which is between the second face F2 and third face F3 (and even between an internal masking layer and the third face F3), in particular for masking of a light source and of a light-redirecting element
an internal electroconductive coating, notably infrared-reflecting (solar control), such as a stack with silver layer(s), on the face F2 on the first, clear sheet, or on an additional notably polymer film
an external electrically conductive coating, in particular infrared-reflecting (low-emissivity), such as a stack with a layer of transparent conductive oxide (TCO, in particular based on indium tin oxide, ITO) on the face F4 of the second sheet made of mineral glass in the first configuration i), or on the face F6 of the second sheet made of mineral glass in the second configuration j).

The laminated glazing according to the invention may also comprise a layer that reflects or absorbs infrared, on face F2 or on a transparent polymer film (PET, etc.) between two intermediate layers, in particular a stack of thin layers comprising at least one metal layer such as silver (and even 2 or 3 or 4), the or each silver layer being arranged between dielectric layers on face F2 or containing ITO for the face F4 or F6.

Mention may be made, as stack containing ITO for the face F4 or F6, of those described in patent US2015/0146286, on the face F4, in particular in examples 1 to 3.

An infrared-reflecting coating is also known from patent application WO2018/206236 and in particular:
a dielectric coating comprising dielectric layers such as silicon nitride and/or silicon oxide layers,
a functional layer based on a transparent conductive oxide (TCO) such as a layer based on indium and tin oxide (ITO),
a dielectric coating comprising dielectric layers such as silicon nitride and silicon oxide layers.

The first and second sheets (and optional third sheet) in particular may be substantially identical in shape and size, for example generally rectangular or quadrilateral (non-parallel longitudinal edges), optionally rounded corners,

The first sheet may be larger than the second sheet, thus protruding beyond this second sheet over at least part (one side or several adjacent or opposite sides) of the periphery thereof, thus optionally second sheet (passenger compartment side) that is smaller with an edge face that is recessed, in particular by at most 10 or 5 cm, from the edge face of the first glass sheet, on one edge or several (longitudinal and/or lateral) edges in particular or over the entire periphery, which is in particular useful when the second sheet is optically coupled by its peripheral edge face to a light source.

Alternatively or cumulatively, the second sheet may be larger than the third sheet, thus protruding beyond this third sheet over at least part (one side or several adjacent or opposite sides) of the periphery thereof, thus optionally third sheet (passenger compartment side) that is smaller with an edge face that is recessed, in particular by at most 10 or 5 cm, from the edge face of the second glass sheet, on one edge or several (longitudinal and/or lateral) edges in particular or over the entire periphery, which is in particular useful when the third sheet is optically coupled by its peripheral edge face to a light source.

The thickness of layer(s) between second face F2 and third face F3 (respectively between F4 and F5) being preferably at most 1.1 mm or 0.9 mm and in particular the thickness of lamination interlayer (respectively other lamination interlayer) being at most 1.1 mm or 0.9 mm, at least in the guide zone.

The thickness between first face F1 and fourth face F4 (where appropriate between F1 and F6) is preferably at most 9 mm or 7 mm, in particular for a road vehicle.

The first sheet made of mineral glass can be silica-based, soda lime-based, preferably soda-lime-silica-based, even aluminosilicate-based, or borosilicate-based, and preferably has a total iron oxide content by weight (expressed in the form Fe₂O₃) of at least 0.4% and preferably of at most 1.5%.

In order to limit absorption, the second sheet made of mineral glass can be in particular silica-based, soda-lime-based, soda-lime-silica-based, or aluminosilicate-based, or borosilicate-based, has a total iron oxide content by weight (expressed in the form Fe₂O₃) of at most 0.05% (500 ppm), preferably of at most 0.03% (300 ppm) and of at most 0.015% (150 ppm) and particularly greater than or equal to 0.005%. The redox of the second glass sheet is preferably greater than or equal to 0.15.

The second sheet may be made of polymer in particular based on polyurethane (PU), typically with n1 of approximately 1.47, on polycarbonate (PC), typically with n1 of approximately 1.59, on polymethyl methacrylate (PMMA), typically with n1 of approximately 1.47, on polyvinyl chloride (PVC), with n1 of approximately 1.54.

The second sheet may be flexible to follow the curvature of the first curved or preformed sheet.

The first glass sheet, and even the second and/or third glass sheet, can be produced by the float process, enabling a perfectly flat and smooth sheet to be obtained, or produced by drawing or rolling processes.

By way of examples of glass, float glass with a conventional soda-lime composition, optionally thermally or chemically hardened or tempered, an aluminum or sodium borosilicate or any other composition can be cited.

In the present text, the light transmission is calculated for example from the transmission spectrum between 380 and 780 nm, taking into account the illuminant A and the CIE 1964 standard observer (10°).

The laminated glass roof according to the invention may include one of the following sequences (strict or open):
first glass sheet (tinted or clear with electrically conductive coating, infrared (IR)-reflecting coating, etc. on face F2)/thermoplastic upper intermediate layer (PVB, TPU or EVA)/functional element (tinted or with variable scattering, functional film, photovoltaic)/additional intermediate layer (PVB, TPU, EVA)/coated substrate/thermoplastic lower (clear) intermediate layer (PVB, TPU or EVA) or adhesive crosslinked polymer material (EVA, adhesive polyacrylate, etc.)/second glass sheet (extraclear)
first glass sheet (tinted or clear with electrically conductive coating, IR-reflecting on face F2)/thermoplastic upper intermediate layer (PVB, TPU or EVA)/functional element (tinted or with variable scattering, functional film, photovoltaic)/additional intermediate layer (PVB, TPU, EVA)/coated substrate/thermoplastic lower (clear) intermediate layer (preferably TPU or EVA) or adhesive crosslinked polymer material (EVA, adhesive polyacrylate, etc.)/second polymer sheet (PMMA, PC).
first glass sheet (tinted or clear with electrically conductive coating, IR-reflecting on face F2)/thermoplastic upper lamination interlayer (PVB, TPU or EVA)/functional element (tinted or with variable scattering, functional film, photovoltaic)/additional intermediate layer (PVB, TPU, EVA)/coated substrate/thermoplastic lower (clear) intermediate layer (PVB, TPU or EVA) or adhesive crosslinked polymer material (EVA, adhesive polyacrylate, etc.)/second glass sheet/other lamination interlayer/third glass or polymer sheet
first glass sheet (tinted or clear with electrically conductive coating, IR-reflecting on face F2)/thermoplastic upper intermediate layer (PVB, TPU or EVA) or adhesive crosslinked polymer material (EVA, adhesive polyacrylate, etc.)/functional element (tinted or with variable scattering, functional film, photovoltaic)/lower intermediate layer (PVB, TPU, EVA)/second glass or polymer sheet (PMMA, PC)/other thermoplastic upper intermediate layer (PVB, TPU or EVA) or adhesive crosslinked polymer material (EVA, adhesive polyacrylate, etc.)/coated substrate/other thermoplastic lower (clear) intermediate layer (PVB, TPU or EVA) or adhesive crosslinked polymer material (EVA, adhesive polyacrylate, etc.)/third glass sheet (extraclear).

For example, preferably:
first glass sheet (tinted or clear with electrically conductive coating, IR-reflecting on face F2)/thermoplastic PVB upper intermediate layer (clear or tinted) functional element (tinted or with variable scattering, functional film, photovoltaic)/additional intermediate layer (PVB)/coated substrate/thermoplastic PVB lower (clear) intermediate layer or adhesive crosslinked polymer material (EVA, adhesive polyacrylate, etc.)/second glass sheet (extraclear)
first glass sheet (tinted or clear with electrically conductive coating, IR-reflecting on face F2)/thermoplastic PVB upper intermediate layer functional element (tinted or with variable scattering, functional film, photovoltaic)/additional intermediate layer (PVB)/coated substrate/thermoplastic lower intermediate layer (preferably TPU or EVA) or adhesive crosslinked polymer material (EVA, adhesive polyacrylate, etc.)/second polymer sheet (PMMA, PC).
first glass sheet (tinted or clear with electrically conductive coating, IR-reflecting on face F2)/thermoplastic PVB upper intermediate layer or adhesive crosslinked polymer material (EVA)/functional element (tinted or with variable scattering, functional film, photovoltaic)/lower intermediate layer (PVB, TPU, EVA)/second glass sheet/other thermoplastic upper intermediate layer (PVB, TPU or EVA) or adhesive crosslinked polymer material (EVA, adhesive polyacrylate, etc.)/coated substrate/other thermoplastic lower intermediate layer (PVB, TPU or EVA) or adhesive crosslinked polymer material (EVA, adhesive polyacrylate, etc.)/third glass sheet (extraclear).

The invention also relates to a motor vehicle incorporating the illuminable laminated glass roof defined above, in particular a fixed roof (canopy).

For the motor vehicle roof, a light transmission of at most 40% or even of at most 28% and even of at most 8% is chosen in the clear glass area and preferably of at least 3% or at most 1% in the tinted state, with a device having a variable tint.

In the present application, a road vehicle is understood to be a car, particularly a commercial vehicle (van, small truck, dispatch van) weighing less than 3.5 tons (light utility vehicle), or even can be a truck or even a shuttle, small private or public transport vehicle.

The clear glass area is thus a central area.

This clear glass area generally represents at least 20%, preferably at least 50% and in particular at least 70% or 80% or 90% or 95% of the total surface area of the glazing, including the zones covered by an encapsulation or seals. In other words, the internal opaque masking layer covers a zone that generally represents at most 80%, preferably at most 50% and in particular at most 30% or 20% or 10% or 5% of the total surface area of the glazing.

The optical density of the opaque layer is preferably at least 2 and even up to 5.

The lamination interlayer can occupy at least 70%, 80%, 90%, 95% or even 100% of the surface area of the glazing.

The second face F2 may be the tin face or the face opposite, or the first face F1 may be the tin face.

The third face F3 may be the tin face, or the fourth face F4 may be the tin face. The fifth face F5 may be the tin face, or the sixth face F6 may be the tin face.

Other details and advantageous features of the invention will become apparent upon reading the examples according to the invention shown by the following figures.

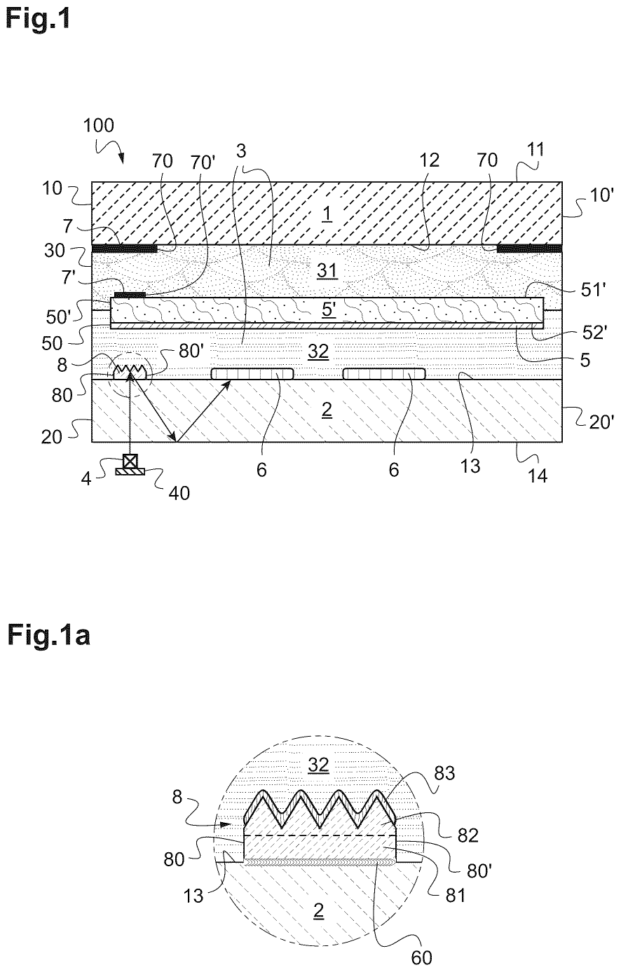

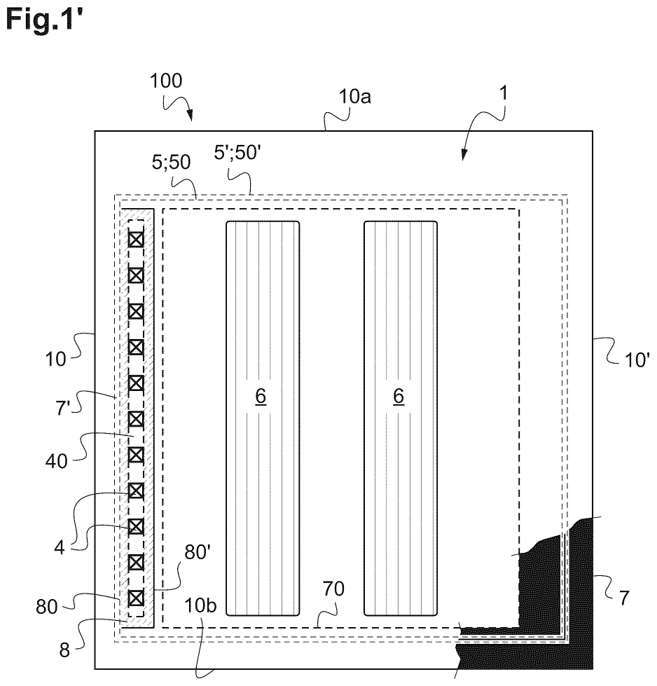

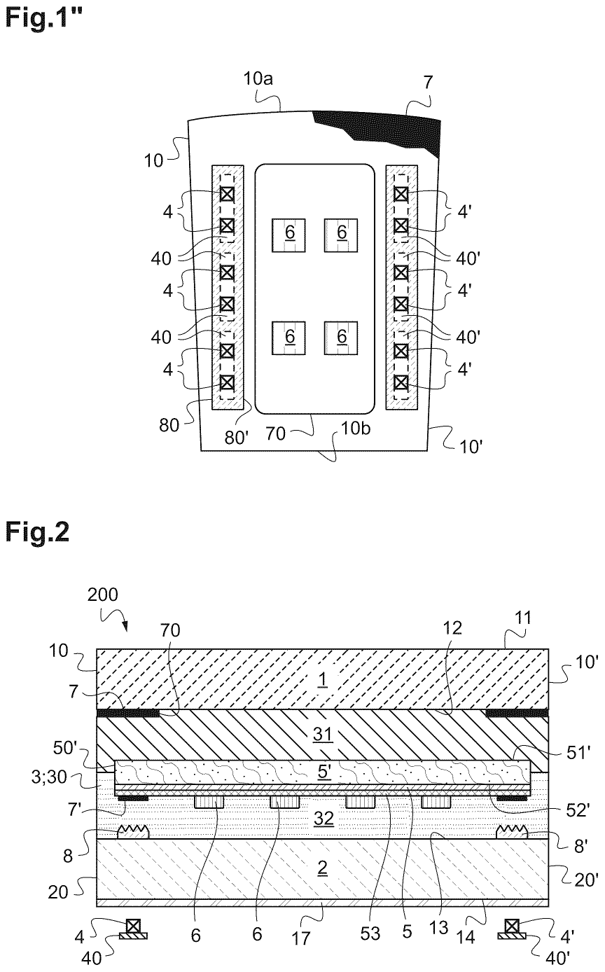

FIG. 1 shows a schematic sectional view of an illuminable laminated sunroof 100 for a motor vehicle according to the invention in a first embodiment. FIG. 1a shows a detail view of the reflective prismatic film used to redirect light. FIG. 1′ shows a schematic front view of roof of FIG. 1. FIG. 1″ shows a schematic front view of a variant of the roof 100.

FIG. 2 shows a schematic sectional view of an illuminable laminated sunroof 200 for a motor vehicle according to the invention in a second embodiment.

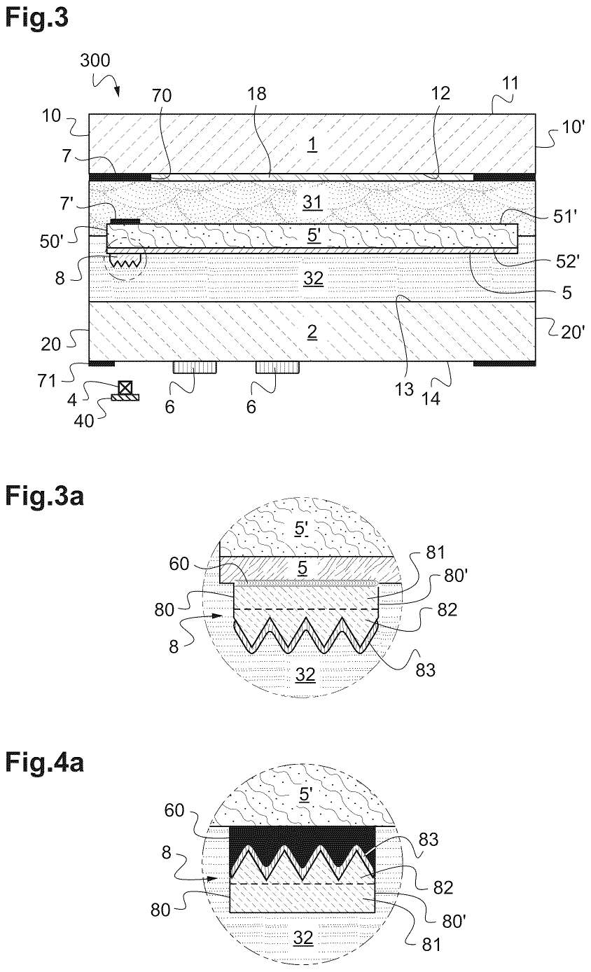

FIG. 3 shows a schematic sectional view of an illuminable laminated sunroof 300 for a motor vehicle according to the invention in a third embodiment. FIG. 3a shows a detail view of the reflective prismatic film then used to redirect light.

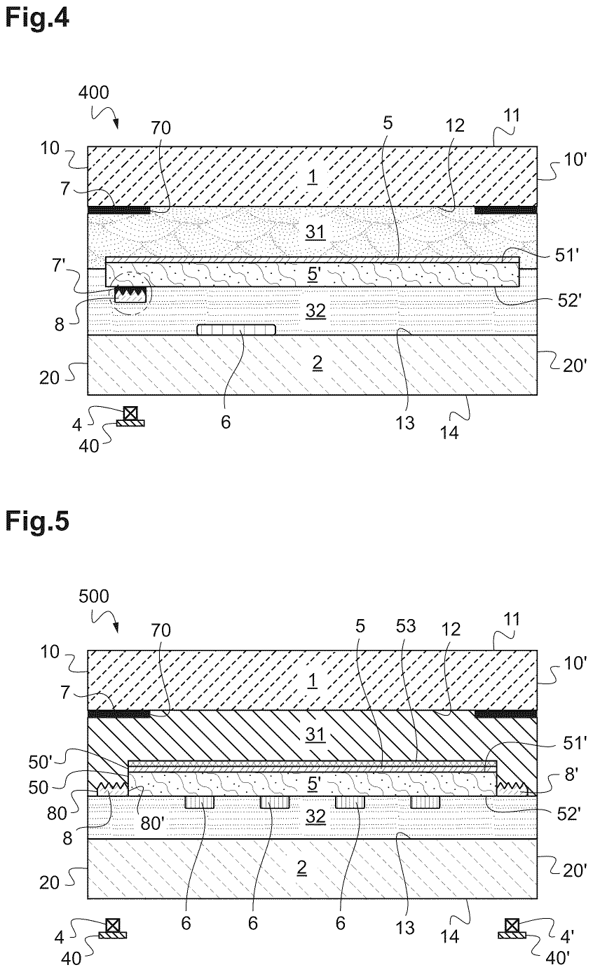

FIG. 4 shows a schematic sectional view of an illuminable laminated sunroof 400 for a motor vehicle according to the invention in a fourth embodiment. FIG. 4a shows a detail view of the reflective prismatic film then used to redirect light.

FIG. 5 shows a schematic sectional view of an illuminable laminated sunroof 500 for a motor vehicle according to the invention in a fifth embodiment.

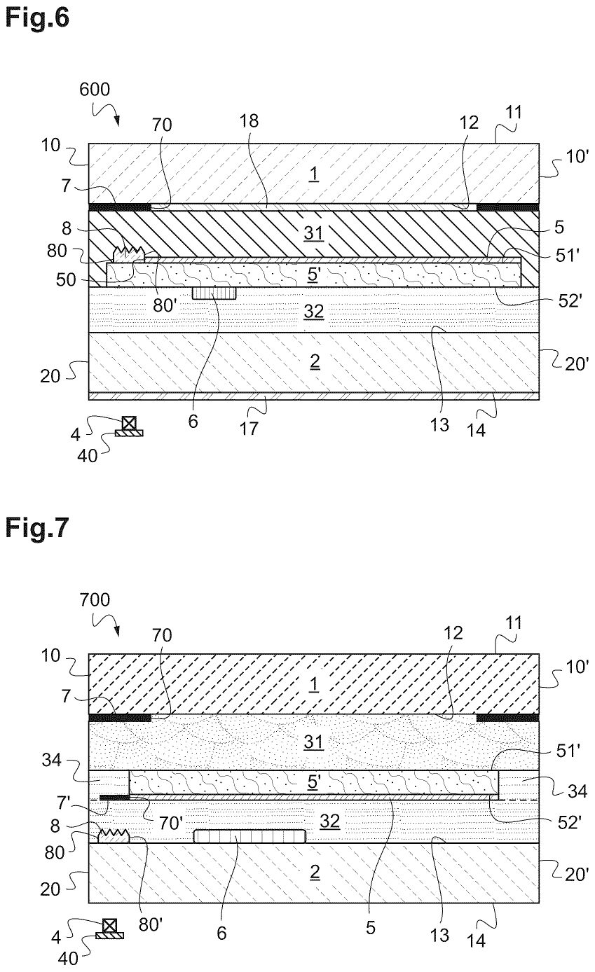

FIG. 6 shows a schematic sectional view of an illuminable laminated sunroof 600 for a motor vehicle according to the invention in a sixth embodiment.

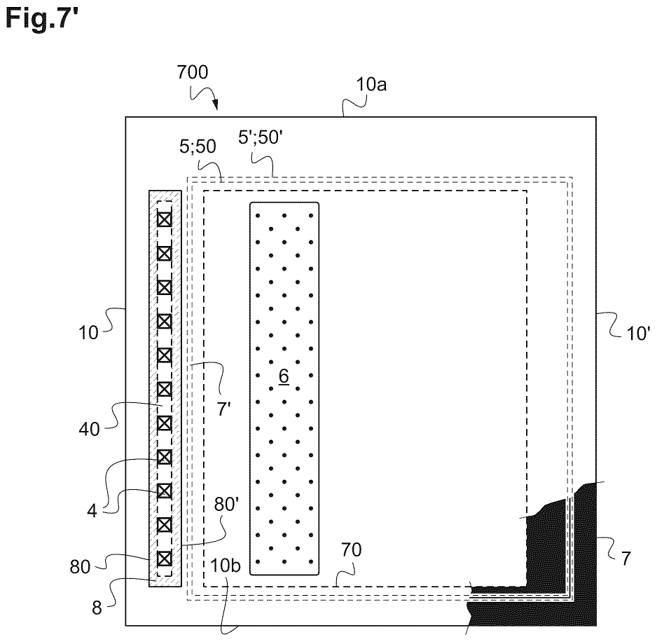

FIG. 7 shows a schematic sectional view of an illuminable laminated sunroof 700 for a motor vehicle according to the invention in a seventh embodiment. FIG. 7′ shows a schematic front view of the glazing of FIG. 7.

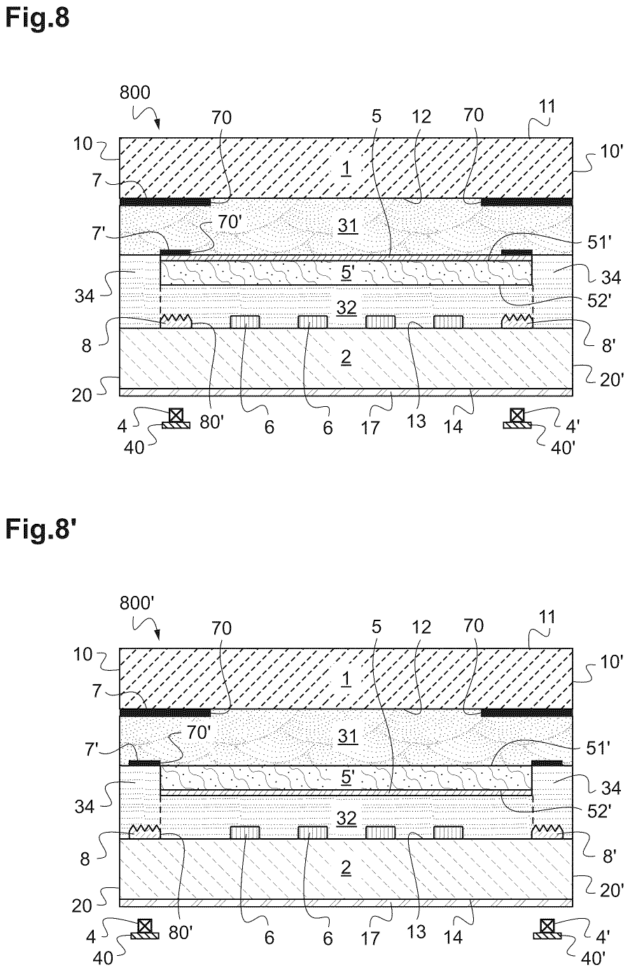

FIG. 8 shows a schematic sectional view of an illuminable laminated sunroof 800 for a motor vehicle according to the invention in an eighth embodiment.

FIG. 8′ shows a schematic sectional view of an illuminable laminated sunroof 800′ for a motor vehicle according to the invention in a variant of the eighth embodiment.

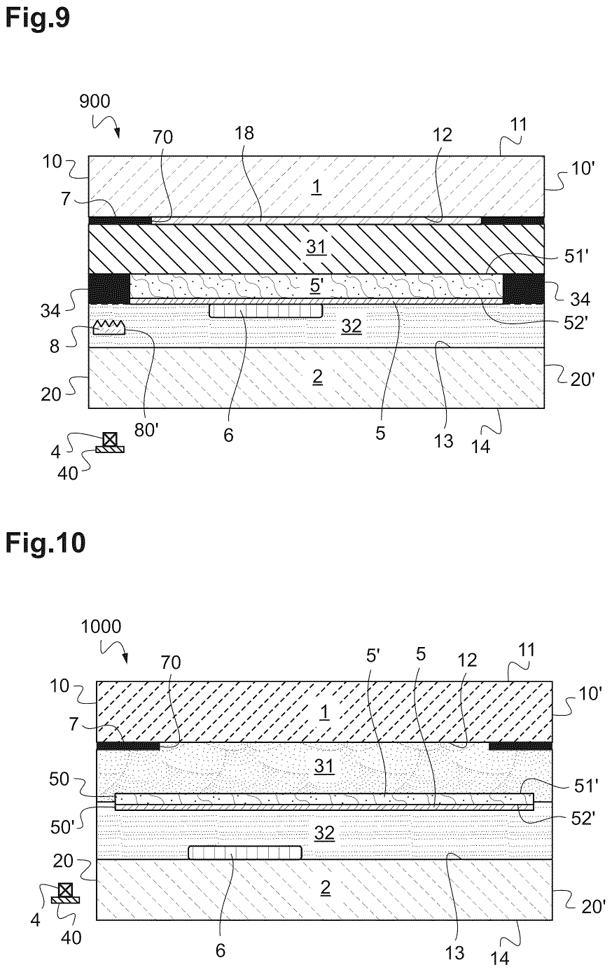

FIG. 9 shows a schematic sectional view of an illuminable laminated sunroof 900 for a motor vehicle according to the invention in a ninth embodiment.

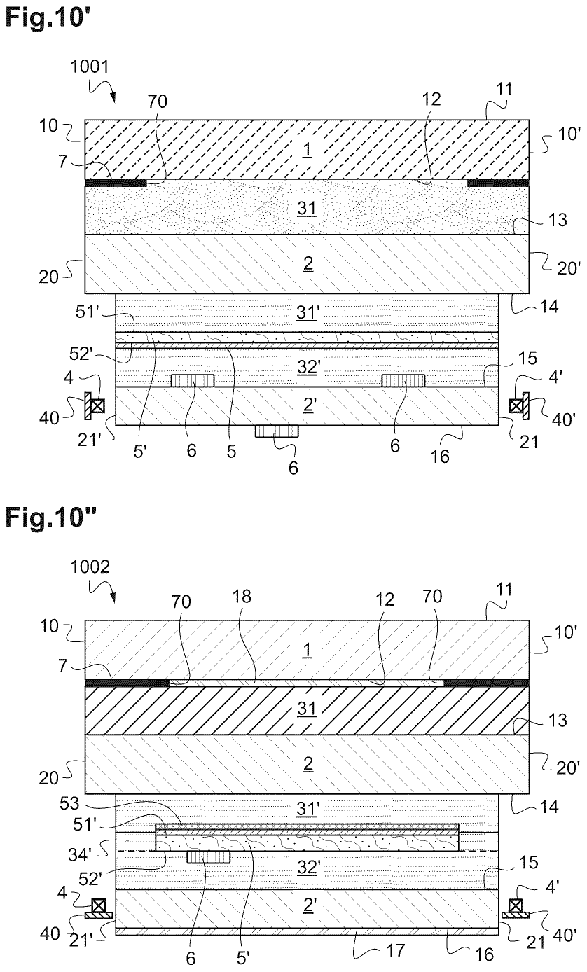

FIG. 10 shows a schematic sectional view of an illuminable laminated sunroof 1000 for a motor vehicle according to the invention in a tenth embodiment.

FIG. 10′ shows a schematic sectional view of an illuminable laminated sunroof 1001 for a motor vehicle according to the invention in an embodiment with a third sheet.

FIG. 10″ shows a schematic sectional view of an illuminable laminated sunroof 1002 for a motor vehicle according to the invention in an embodiment with a third sheet.

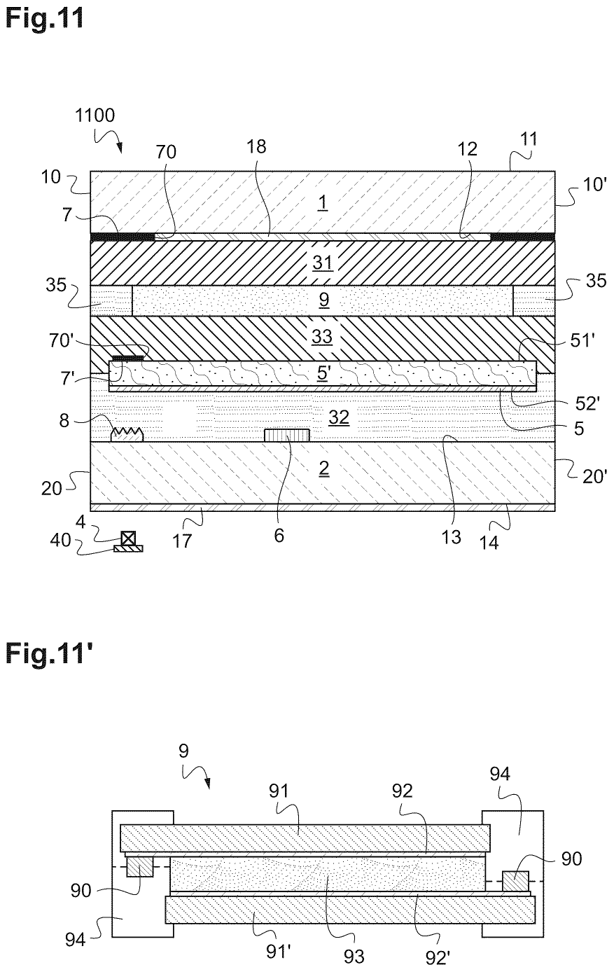

FIG. 11 shows a schematic sectional view of an illuminable laminated sunroof 1100 for a motor vehicle according to the invention in an eleventh embodiment. FIG. 11′ shows a schematic sectional view of the electrically controllable device having variable scattering inserted in the roof of FIG. 11.

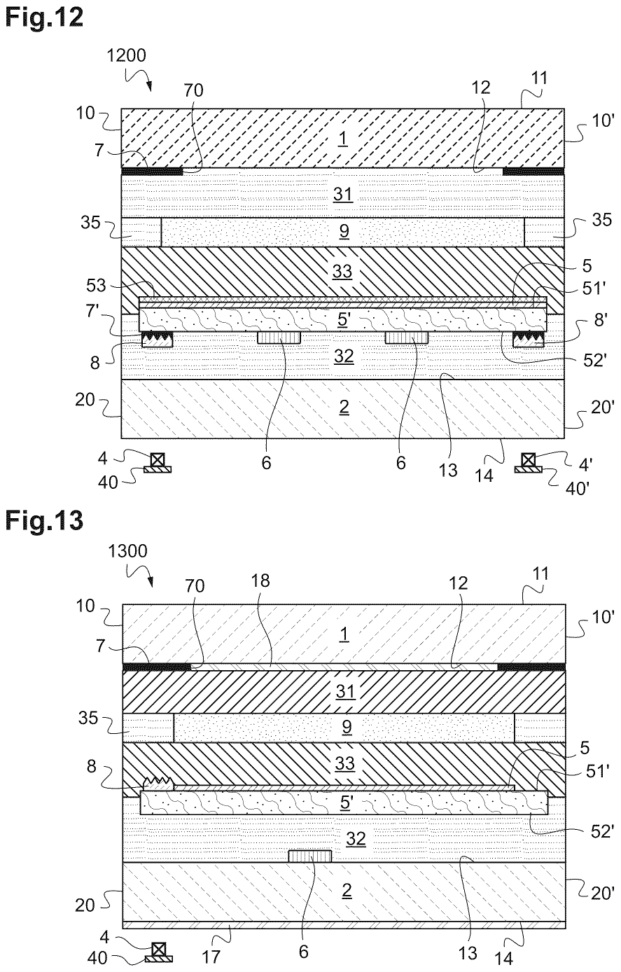

FIG. 12 shows a schematic sectional view of an illuminable laminated sunroof 1200 for a motor vehicle according to the invention in a twelfth embodiment.

FIG. 13 shows a schematic sectional view of an illuminable laminated sunroof 1300 for a motor vehicle according to the invention in a thirteenth embodiment.

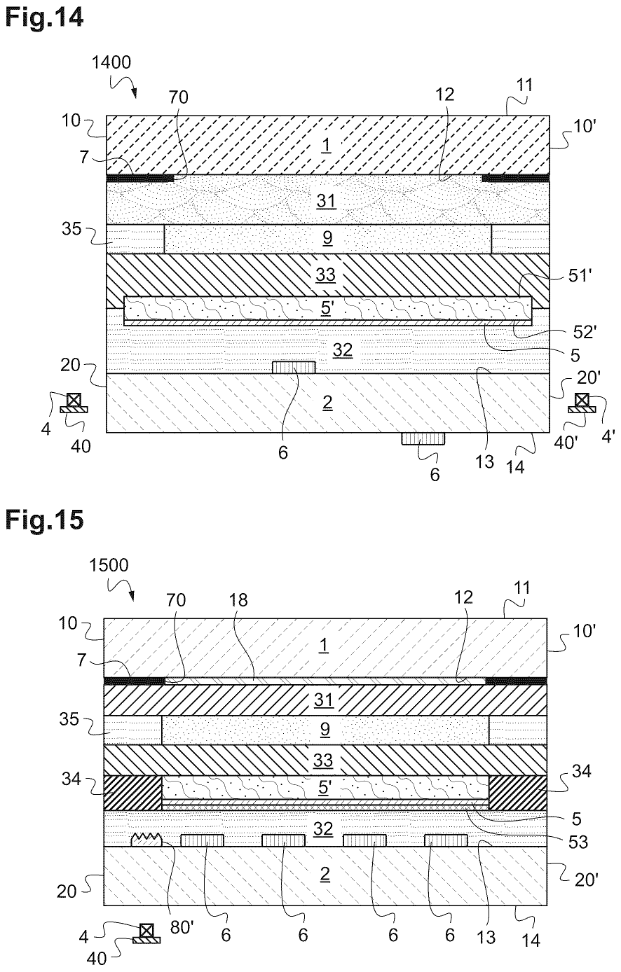

FIG. 14 shows a schematic sectional view of an illuminable laminated sunroof 1400 for a motor vehicle according to the invention in a fourteenth embodiment.

FIG. 15 shows a schematic sectional view of an illuminable laminated sunroof 1500 for a motor vehicle according to the invention in a fifteenth embodiment.

FIG. 16 shows a schematic sectional view of an illuminable laminated sunroof 1600 for a motor vehicle according to the invention in a sixteenth embodiment.

FIG. 17 shows a schematic sectional view of an illuminable laminated sunroof 1700 for a motor vehicle according to the invention in a seventeenth embodiment.

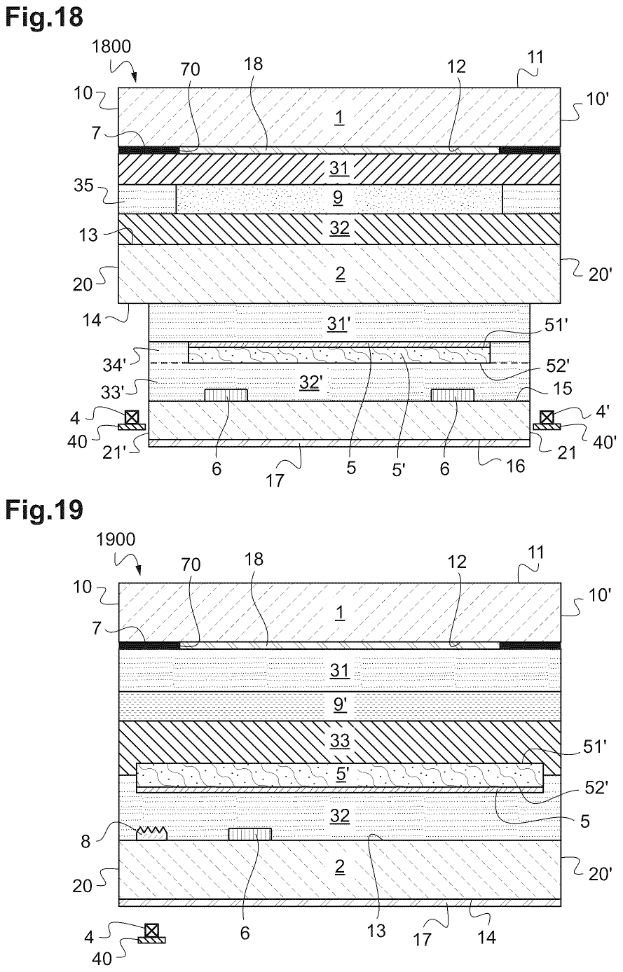

FIG. 18 shows a schematic sectional view of an illuminable laminated sunroof 1800 for a motor vehicle according to the invention in an eighteenth embodiment.

FIG. 19 shows a schematic sectional view of an illuminable laminated sunroof 1900 for a motor vehicle according to the invention in a nineteenth embodiment.

For the sake of clarity, it should be noted that the various elements of the objects that are shown are not necessarily reproduced to scale.

FIG. 1 shows a schematic sectional view, herein lateral, of a luminous laminated roof 100 for a vehicle according to the invention in a first embodiment with peripheral illumination. FIG. 1′ shows a schematic front view of roof of FIG. 1. In particular, for a fixed roof (canopy), the width is 85 cm to 1.4 m and the length is 75 cm to 1.65 m.

In this case, this is a laminated car roof 100 that is rectangular and is bent (in one or more directions), which comprises:
a first glass sheet 1, for example rectangular (dimensions 1600×1100 mm, for example), with a tinted composition (VENUS VG10 or TSA 4+ glass, sold by Saint-Gobain Glass having a light transmission or LT of approximately 28%) for example having a thickness equal to 2.1 mm, with a first main face 11 corresponding to face F1, a second main face 12 referred to as face F2 and a rim (longitudinal edge faces 10 and 10′), face F2 being optionally coated with a transparent functional (heating, etc.) coating, or even face F1,
a second transparent sheet, preferably mineral glass, 2, here having the same shape and dimensions as the first sheet 1, forming internal glazing on the passenger compartment side, having a third main face 13 or face F3 and a fourth main face 14 or face F4, and a rim (longitudinal edge faces 20 and 20′—for example a sheet of extraclear soda-lime-silica glass such as Diamant glass sold by Saint-Gobain Glass having an LT of at least 91%, a thickness for example equal to 2.9 mm, which glass has a refractive index n1 of approximately 1.52 at 600 nm or the Optiwhite glass of 1.95 mm, or the Sunmax glass of 2.05 mm.
between the face F2 and the face F3, a transparent lamination interlayer 3, with an edge face 30, in this case longitudinal, which are aligned or even optionally offset from the longitudinal edge faces 10, 10′ toward the center of the glass (i.e. recessed), here comprising:
an upper intermediate layer 31, in particular thermoplastic, here based on PVB (with plasticizers, at least 30% by weight), of 0.38 mm or 0.76 mm (in one or two sheets) in adhesive contact with the face F2, clear or, as a variant, tinted, for example tinted gray with an LT of 27%
a PVB lower intermediate layer 32 (with plasticizers, at least 30% by weight), clear (as transparent as possible and with as few optical defects as possible), of 0.38 mm or 0.76 mm (in one or two sheets) in adhesive contact with the face F3, having a refractive index n3 of approximately 1.48 at 600 nm, for example PVB having an LT at 99.9%.

Alternatively, the lower intermediate layer 32 is based on PVB with no or plasticizers or few plasticizers (in particular less than 5% by weight), in particular MOWITAL film, for example having a thickness of at most 100 μm.

Alternatively, the lower intermediate layer 32 is based on crosslinked polymeric adhesive material, in particular adhesive polyacrylate film or adhesive silicone film, in particular of at least 30 μm, or else it is an adhesive coating (polyacrylate, etc.) obtained by deposition on the third face F3 or on the coated substrate or deposited between the third face F3 and the coated substrate (by filling).

The laminated sunroof 100 comprises an internal masking layer 7 forming a masking frame delimiting a clear glass area 70 (daylight), in this case rectangular (see FIG. 1′) with straight edges. Any local modification of the edges 70 is possible (shaded in dots, wider zone, etc.). For example, the internal masking layer 7 is:
a black enamel on face F2
or a black ink, on one of the faces of the upper intermediate layer, preferably the face oriented toward face F2, preferably based on PVB with black pigments if the upper intermediate layer 31 is PVB.
the masking width at the front (front lateral edge side 10a) is for example from 10 to 40 cm
the masking width at the rear (rear lateral edge side 10b) is for example from 5 to 25 cm
the masking width on the long sides (longitudinal edges) is for example from 5 to 20 cm, which width is identical or different for the two long sides.

In order to optically insulate a lower part (with light guide and light extraction) and the tinted, absorbing upper part, the laminated sunroof 100 further comprises an optical insulating coating 5 on one of the front faces Fa 51′ (face F2 side), or in a variant or rear Fb 52′ (face F3 side), as here, then referred to as coated (or deposited) face of a transparent film 5′, preferably polymer and different from a fluoropolymer. The assembly is referred to as coated substrate. The coated substrate is sandwiched between the upper intermediate layer 31 and the lower intermediate layer 33, extends throughout the clear glass area and beyond, its edge face 50, 50′ being under the masking layer 7.

The coated substrate is recessed from the edges 10, 10′, 20, 20′ of the sheets 1, 2, notably by at least 10 mm. The transparent film and even the coated substrate herein is of a thickness of less than 200 μm or even of at most 100 μm and is protected at the periphery by one or both lower and upper intermediate layers 31, 32 (in particular creep during lamination). If the upper intermediate layer is clear, the interface between the two lower and upper intermediate layers 31, 32 may be indiscernible.

The optical insulating coating 5 is made of a material, preferably polymer, comprising a matrix separate from a fluoropolymer of submillimetric thickness Ei, of at least 400 nm and better still 500 nm or 800 nm, and an edge face 50 optionally recessed from the edge face of the film 50′ without harming the optical insulating function. The optical insulating coating may be directly or on a transparent functional underlayer (barrier, etc.) on the film 5′.

The film 5′ is transparent but can be tinted.

The optical insulating coating 5 is transparent and even as transparent as possible.

In one configuration, the optical insulating coating comprises a crosslinked polymer matrix having said index n2, preferably of at most 1.42, and even at most 1.35, which matrix is preferably from polymers based on polyacrylate with a fluorinated function, in particular urethane acrylate or fluorinated urethane acrylate or fluorosilicone acrylate. The thickness is preferably at most 10 μm or 5 μm or 2 μm and at least 800 nm.

In one configuration, the optical insulating coating comprises a matrix having a refractive index n2ₘ greater than n2 and less than n1, and n2ₘ is preferably at most 1.48 (and n2 is preferably at most 1.42, and even at least 1.35), and comprising (nano) porosities and/or low-index and/or porous, hollow (nano) particles, with a refractive index of less than n1 in particular hollow, with a size of at most 300 nm or even 100 nm, for example hollow silica nanoparticles. The thickness is preferably at most 10 μm or 5 μm and at least 800 nm.

The matrix is crosslinked or thermoplastic polymer, in particular chosen from polymers based on polyacrylate, polyepoxides, polyvinyl acetate, polyester, polyurethane, PVB, or is mineral, in particular silica. It is preferred when the polymer matrix is based on polyacrylate, polyurethane or even polyepoxides, polyvinyl acetate, polyester.

Alternatively, the film 5′ is an ultra-thin glass and/or the coating 5 is porous silica.

In order to avoid wrinkles and ripples, preferably the coated substrate can be in a zone of the roof having a curvature, a sphericity limited in particular by a radius of curvature of at least 1.5 m. For example, the edge face 50 may be sufficiently far away from the edge face of the sheets 1, 2. It is possible to adjust (increase) the masking width on the sides and/or front and rear for this purpose.

For example, the transparent film 5′ is a clear PET of less than 200 μm, in particular of 100 μm or 75 μm, with an LT of approximately 90% or more.

For the light function, the laminated sunroof 100 further comprises, masked from the outside by the internal masking layer 7:
light-emitting diodes 4 (herein with front emission) on a support 40 (for example PCB) facing (or offset from) the fourth main face 14,
on the third main face F3 side, a local, peripheral light-redirecting element, such as a reflective prismatic film 8.

For example, the reflective prismatic film is a polymeric prismatic film 8, as shown in the detail view in FIG. 1a, with:
a flat part 81 (for example a PET substrate of at most 100 μm) adhesively bonded or attached by suction to the third face F3 13,
and a textured layer (by embossing, etc.), partially or completely textured, forming prisms 82 that have become reflective by a reflective layer 83, for example metal (by conformal deposition on the textured prismatic surface).

Here, the reflective prismatic film 8 is adhesively bonded by an adhesive 60 to the third main face F3; it may also be held by suction.

The microprisms are schematically in cross section in the form of right triangles, the apex angle can be adjusted to better redirect toward the extraction means. Likewise, the main direction of emission of the light source can be adjusted. A collimator can be added between face F4 and the diodes.

For example, the reflective prismatic film comprises a thermoplastic transparent film for example based on polyethylene terephthalate (PET), on which the transparent prisms are formed from a polyacrylate (resin crosslinked for example by UV), and a metal layer (conformal deposition) to form the reflective prisms.

In another example, a transparent prismatic film (then in the fourth face) comprises a thermoplastic transparent film, for example based on polyethylene terephthalate (PET), on which the transparent prisms are formed from a polyacrylate (resin crosslinked for example by UV). Alternatively, a macroprism can be used on face F4.

The reflective prismatic film 8 is in adhesive contact here with the lower intermediate layer 32. The film forms a longitudinal strip, like the linear-type light source 4, along a longitudinal edge of the roof, for example as seen in FIG. 1′.

As a variant, the prismatic film 81, 82 is a monolithic polymer film, for example preformed, and the reflective layer 83 is applied.

The light coming from the diodes is refracted in the second glass, in the reflective prismatic film 8, then redirected at a given angle toward the light extraction means 6, here on the third face F3, for example scattering ink and as transparent as possible, if desired, and in the clear glass area. The light rays propagate by total internal reflection at the face F4, and:
for some, by total internal reflection at the interface between lower lamination intermediate layer 32 and second sheet, up to the extraction means (via the surface on the face F3 side)
and even for others at the interface between lamination intermediate layer 32 and optical insulating coating 5 and reach the scattering means via the surface on the face F2 side).

Here, the reflective prismatic film 8 is under the optical insulating coating 5, under the coated substrate. By way of precaution, to prevent parasitic light passing through the film and even the masking layer 7, an internal opaque element 7′ is optionally added in line with the prismatic film 8 (of the same width and not protruding beyond the internal edge 80′ of the film 8), here an opaque (black) ink on the front face 51′ of the film 5′ or else a black PET film adhesively bonded to or placed on top.

As a variant, a microprism or a transparent prismatic film is selected on the face F4 side, downstream of the diodes.

The diodes and/or their support may be integral with the face F4 (by an additional part, etc.). As a variant, the diodes are side-emitting.

It is possible to double the means, therefore, by adding another light source 4′ to the support 40′ thereof, another reflective prismatic film 8′ along the other longitudinal edge 10′, as seen in FIG. 1″. Here, the longitudinal edges 10, 10′ are not parallel. In particular, it is possible to have a set of strips of diodes on each side, on mutually separate or interconnected supports 40. It is also possible to place them on the front or rear edges.

Here, the extraction means 6 are for example extended or point-based geometric patterns, in particular having a width of at most 10 mm in order to prevent the phenomenon of shadowing.

For example, the distance between the extraction extraction means 6 and the diodes (or the prismatic film 8) is at least 10 mm or 40 mm.

For example, the extraction means comprise a scattering coating (array of disjointed and/or interconnected patterns) in contact with the face F3 and covering at most 40% of the clear glass area in order to promote adhesion with the second sheet 2. The scattering coating is deposited on the face F3 (for example a semi-transparent enamel) or on the main face of the lower PVB layer 32 oriented toward the face F3. The scattering coating 6 is polymeric or mineral and is deposited by a liquid process (by inkjet, screen printing, etc.).

For example, the scattering coating is on the face F3 (or even F4), for example with an acrylate matrix, preferably having a refractive index greater than or equal to n1, with particles of TiO2 of 100 nm in diameter and preferably of at most 1 μm or 400 nm. It has a thickness of 10 μm to 100 μm, or even 50 μm. The scattering coating (for example based on PVB with particles of TiO2 of 100 to 200 nm in diameter) is alternatively deposited on the face of the PVB oriented toward the face F3.

As a variant, the scattering coating (for example based on PVB with particles of TiO2 of 100 to 200 nm in diameter) is deposited on the face of the PVB 32 oriented toward the face F2, and is then in contact with the optical insulating coating (or in contact with the rear face if the optical insulating coating is moved to the front face). For example, the scattering coating (array of disjointed and/or interconnected patterns) in contact with the optical insulating coating (or the rear face if the optical insulating coating is moved to the front face) covers at most 50% of the clear glass area to promote adhesion of the optical insulating coating (or the rear face if the optical insulating coating is moved to the front face) with the lower intermediate layer.

The luminous glazing 100 may have a plurality of extraction zones 6, in particular of given geometry (rectangular, square, round, etc.). Alternatively to the scattering layer 6 (enamel, ink, screen printed or printed by ink jet, etc.) this may be a local film, placed or adhesively bonded locally on the third face F3 or even fourth face F4 (prismatic film or with scattering layer or scattering in the bulk) or between the PVB 32 and the film 5′.

Alternatively, the light source may be one or more primary sources (diodes, etc.) coupled directly to a guide, along the coupling edge face, for example extracting optical fibers with light output zone.

It is possible to choose diodes emitting in white or colored light for ambient lighting, reading, etc.

It is possible to provide several series of diodes 4 (one edge, two edges, three edges, over the entire periphery) controlled independently and even of different colors.

For the manufacture of the roof, it is possible:
to stack the different elements 31, 5′ with 5, 32 on the second glass sheet 2 then to carry out the lamination
or to stack the different elements 32, 5′ with 5, 31 on the first glass sheet 1 then to carry out the lamination.

FIG. 2 shows a schematic sectional view of an illuminable laminated sunroof 200 for a motor vehicle according to the invention in a second embodiment.

This roof 200 differs from the preceding roof 100 in that:
another light source 4′ is added to support 40′ and another reflective prismatic film 8′ is added to an opposite (or alternatively adjacent) edge and the addition of an internal opaque element
the internal opaque elements 7′ are on the rear face 52′ of the film 5′, on the optical insulating coating 5 (or locally removed), for example black ink or black PET, adhesively bonded or placed
the upper intermediate layer 31 is tinted, for example gray
an IR-reflecting coating 17 on face F4, forming a low-emissivity layer.

Furthermore, a protective transparent layer 53, in particular polymeric, having a refractive index greater than n2, of submillimetric thickness and even of at most 100 μm or even 30 μm, is on and covers the optical insulating coating 5 in particular for the purposes of mechanical protection if the optical insulating coating comprises (nano) porosities and/or (nano) particles of low index, in particular hollow and/or porous particles. Here, this protective transparent layer is a protective coating 53, deposited on the optical insulating coating 5. This may be the same matrix as the optical insulating coating 5 without the (nano) porosities and/or the (nano) particles of low index.

Optionally, the scattering coating 6, for example a set of patterns of identical width, is not on the face F3 side or face F4 side but is printed on the face of the PVB 32 on the face F2 side, therefore is in local contact with this protective transparent layer 53.

Alternatively, the film 5′ is an ultra-thin glass (UTG) and/or the optical insulating coating 5 is porous silica and the protective coating 53 is dense silica, for example coatings 5, 53 obtained by the sol-gel route.

The transparent, single-layer or multilayer infrared-reflecting coating 17 comprises at least one electrically conductive functional layer, for example a transparent conductive oxide, in particular ITO. The infrared-reflecting coating preferably includes a dielectric sublayer, in particular (oxy) silicon nitride, and preferably includes a dielectric layer in particular (oxy) silicon nitride.

FIG. 3 shows a schematic sectional view of an illuminable laminated sunroof 300 for a motor vehicle according to the invention in a third embodiment. FIG. 3a shows a detail view of the reflective prismatic film then used to redirect light.

This roof 300 differs from the first roof 100 in that:
the exterior glass 1 is clear, in particular a 2.1 mm Planiclear glass with an IR-reflecting coating (silver stack, forming solar control) 18, the assembly having an LT of 71.8% (91% without coating 18), the upper intermediate layer 31 is tinted or optional the upper intermediate layer 31 is clear but a light scattering source
the prismatic film 8 has been moved (detailed view in FIG. 3a) to the rear face 51 and turned upside down, with the reflective prisms (the reflective coating) facing face F3
optionally, if required, an interior masking layer 71 is on the face F4 14 without interfering with the injection from the light source 4 (optionally locally reduced width)
optionally the scattering coating 6 is herein on face F4 14, for example an enamel or is alternatively on the PVB 32 and/or on face F3 or face Fb side.

With such an inverted film configuration, the substrate 80 and/or the prisms 82 and/or the adhesive 60 (on the coating 5 or on the bare face Fb) may be tinted and even opaque and then element 7′ may be more optional. The inverted film (preferably with opaque part) may be adjacent to the coated substrate (inner edge 80′ close to the edge 50′). It is possible to duplicate the inverted film and light source (as shown in FIG. 2).

FIG. 4 shows a schematic sectional view of an illuminable laminated sunroof 400 for a motor vehicle according to the invention in a fourth embodiment. FIG. 4a shows a detail view of the reflective prismatic film then used to redirect light.

This roof 400 differs from the first roof 100 in that:
the optical insulating coating 5 is on the front face 51′, then the transparent film (PET etc.) 5′ is selected to be clear,
the internal opaque element 7′ is on the rear face 52′ side of the film 5′, on the optical insulating coating 5 (or locally removed) in the form of a black adhesive 60 serving to attach the prismatic film 8 (detail view in FIG. 4a) thus attached to the coated substrate, still under the internal masking layer 7, outside the clear glass area 70.

FIG. 5 shows a schematic sectional view of an illuminable laminated sunroof 500 for a motor vehicle according to the invention in a fifth embodiment.

This roof 500 differs from the first roof 100 in that:
the upper intermediate layer 31 is for example tinted, notably gray (the glass 1 is tinted or clear and even with a layer 18)
the optical insulating coating 5 is on the front face 51′, then the film 5′ (polymer, PET) is selected to be clear, and even protected by a protective layer 53 (for example similar to that described in FIG. 2)
the reflective prismatic film 8 is between the upper intermediate layer 31 and the lower intermediate layer 32, in particular in adhesive contact with these layers (but it is possible to add an adhesive, for example black on the face F2 side).

The internal opaque element 7′ is omitted in particular, the gray PVB 31 may be sufficient.

The light source and reflective prismatic films 4′, 40, 8′ have been doubled.

The inner edge 80′ of each reflective prismatic film 8, 8′ is at most 4 mm, preferably at most 1 mm away from the external edge (of the edge face 50′) of the optical insulating coating and is even in contact with the edge face 50′ of the film 5′.

Optionally, the scattering coating 6, for example a set of patterns of identical width, is not on the face F3 side or face F4 side but is printed on the face of the PVB 32 on the face F2 side, therefore is in local contact with the rear face 52′.

FIG. 6 shows a schematic sectional view of an illuminable laminated sunroof 600 for a motor vehicle according to the invention in a sixth embodiment.

This roof 600 differs from the preceding roof 500 in that:
the exterior glass 1 is clear, in particular a 2.1 mm Planiclear glass with an IR-reflecting coating (silver stack) 18, the assembly having an LT of 71.8% (91% without coating 18)
the reflective prismatic film 8 is in adhesive contact with the upper intermediate layer 31 (but it is possible to add an adhesive, for example black, on the face F3 side), on the front face 51′ of the coated substrate
the protective layer is herein omitted, for example, the optical insulating coating 5 is a low-index polymer, for example crosslinked
a low-emissivity coating 17 is on face F4.

The light source and reflective prismatic films can be duplicated.

FIG. 7 shows a schematic sectional view of an illuminable laminated sunroof 700 for a motor vehicle according to the invention in a seventh embodiment. FIG. 7′ shows a schematic front view of roof of the roof 700.

This roof 700 differs from the first roof 100 in that the film 5′ is 200 μm or more and, to compensate for this large thickness, an intermediate frame layer 34, made of PVB, here clear, is added.

The internal edge 80′ of the prismatic film 8 is aligned with the edge face 50 of the coated substrate, and even of the optical insulating coating 5. The internal opaque element 7′ is between the PVB intermediate frame layer 34 and the lower intermediate layer 32, still in line with the prismatic film 8. It may be a black PET or even a black ink on PVB 34 or 32.

FIG. 8 shows a schematic sectional view of an illuminable laminated sunroof 800 for a motor vehicle according to the invention in an eighth embodiment.

This roof 800 differs from the preceding roof 700 in that:
the light source and reflective prismatic films 4′, 40′ have been doubled.
the optical insulating coating 5 is on the front face 51′, then the film 5′ is chosen to be clear,
the lower intermediate layer 32 is the same size as the film 5′, for example a PVB sheet (optionally indiscernible interface with the frame layer 34) or is a coating of pressure-sensitive optical adhesive PSA or else a pressure-sensitive film PSA, for example polyacrylate of at least 30 μm.

The frame layer 34 is therefore thicker and comes into contact with the third face F3.

As a variant, the film 5′ is sufficiently thin, for example less than 200 μm, and the frame layer 34 is removed and the film 5′ is protected by creep of the upper intermediate layer 31.

Alternatively, it is possible to have an inverted film as already described, or a transparent macroprism or a prismatic film (multiprism) on face F4 side.

FIG. 8′ shows a schematic sectional view of an illuminable laminated sunroof 800′ for a motor vehicle according to the invention in a variant of the eighth embodiment.

This roof 800′ differs from the preceding roof 800 in that:
the optical insulating coating 5 is on the rear face 52′, the PET 5′ is clear or tinted,
the light source and the prismatic film 4, 4′, 40, 40′, have optionally been moved closer to the edge, under the frame layer 34
the opaque element 7′ is moved as a result
a low-emissivity layer 17 is on face F4

As a variant, the film 5′ is sufficiently thin, for example less than 200 μm, the frame layer 34 is removed and the film 5′ is protected by creep of the upper intermediate layer 31.

FIG. 9 shows a schematic sectional view of an illuminable laminated sunroof 900 for a motor vehicle according to the invention in a ninth embodiment.

This roof 900 differs from the seventh roof 700 in that:
herein, the PVB intermediate frame layer 34 is opaque (black) and has an LT of at most 5% or even 0%, forming an internal opaque element
optionally, the prismatic reflective film 8 is moved herein embedded in the lower intermediate layer 31,
optionally, the exterior glass 1 is clear, notably a 2.1 mm Planiclear glass with an IR-reflecting coating (silver stack) 18, the assembly having an LT of 71.8% (91% without coating 18), for example the layer 31 is tinted.

Optionally, the scattering coating 6, for example a set of patterns of identical width, is not on the face F3 side or face F4 side but is printed on the face of the PVB 32 on the face F2 side, therefore is in local contact with the optical insulating coating 5.

FIG. 10 shows a schematic sectional view of an illuminable laminated sunroof 1000 for a motor vehicle according to the invention in a tenth embodiment.

This roof 1000 differs from the first roof 100 in that light is injected via the edge face 20 of the second sheet (the reflective prismatic film and the internal opaque element are eliminated).

Preferably, the second sheet 2 is recessed from the first sheet 1 in order to house the light source 4, here, for example, with side emission.

Diodes 4 extend along the longitudinal coupling edge 20 of the second glass sheet 2. The PCB carrier 40 is attached for example by adhesive (or a double-sided adhesive) to the edge 20.

As a variant, the source 4 is housed in a hole of the second sheet 2.

FIG. 10′ shows a schematic sectional view of an illuminable laminated sunroof 1001 for a motor vehicle according to the invention in an embodiment with a third sheet, showing the second configuration j).

This roof 1001 differs from the first roof 100 in that it comprises a third sheet 2′, made of mineral glass or polymer sheet (PC, PMMA), with a fifth main face F5 15, a sixth main face F6 16 and a third edge face 20′, having a refractive index n′1 preferably of at least 1.48 and at most 1.6, in particular from 1.5 to 1.53, which third sheet is bonded with the second sheet via another lamination interlayer 3′, 31′, 32′ comprising another upper intermediate layer 31′ and another lower intermediate layer 32′ in contact with the fifth face F5 and having a refractive index n′3 in the visible range.

The coated substrate 5′, 5 is then moved to be between the other upper and lower intermediate layers 31′, 32′ of said other lamination interlayer, for example made of PVB or TPU or crosslinked material, in particular crosslinked EVA.

n2 is then less than n′1, the difference in refractive indices n′1−n2 being at least 0.06 in the visible range.

Light is injected by the longitudinal (or lateral, as a variant) edge face 21′ of the third sheet (the reflective prismatic film and the internal opaque element are eliminated), which is recessed from the second sheet 2′, for example by at least 1 cm in order to house diodes (here with top or front emission) 4 plus the support 40.

A light source 4′ on the support 40′ thereof has been added to the opposite longitudinal edge and the third sheet is then preferably also recessed from the second sheet.

As a variant, each source 4 is housed in a hole of the third sheet.

FIG. 10″ shows a schematic sectional view of an illuminable laminated sunroof 1002 for a motor vehicle according to the invention in an embodiment with a third sheet.

This roof 1002 differs from the preceding roof 1001 in that:
the diodes 4′ are side-emitting diodes
the exterior glass 1 is clear, in particular a 2.1 mm Planiclear glass with an IR-reflecting coating (silver stack) 18, the assembly having an LT of 71.8% (91% without coating 18)
the upper intermediate layer 31 is tinted, gray, in particular gray PVB
the optical insulating coating 5 is on the front face 51′, then the film 5′ is chosen to be clear, and even protected by a protective layer 53 (for example similar to that described in FIG. 2)
an IR-reflecting coating 17 is on the sixth face F6 16.
since the film is at least 200 μm, an intermediate frame layer 34′ is preferably added between layers 31′ and 32′

As a variant, each source 4 is housed in a hole of the third sheet.

FIG. 11 shows a schematic sectional view of an illuminable laminated sunroof 1100 for a motor vehicle according to the invention in an eleventh embodiment. FIG. 11′ shows a schematic sectional view of the electrically controllable device having variable scattering inserted in the roof 1100.

This roof 1100 differs from the first roof 100 in that it comprises, between the upper intermediate layer 31 and an additional intermediate layer 33, an electrically controllable device, herein having a variable scattering 9, preferably tinted, gray, in particular PVB.

Since the thickness of the device is 0.4 mm, an intermediate frame layer 35 of thickness 0.38 mm is added, made of PVB, clear or tinted. The edges of the device 9 are under the internal masking layer 7.

For example, the haze in the scattering state of the roof with the device is at least 80%.

The coated substrate 5′, 5 is then in adhesive contact with the additional intermediate layer 33 and the lower intermediate layer 32.

The exterior glass 1 is clear, in particular a 2.1 mm Planiclear glass with an IR-reflecting coating (silver stack) 18, the assembly having an LT of 71.8% (91% without coating 18).

Preferably, an IR-reflecting coating 17 is on the face F4.

As shown in FIG. 11′, the variable scattering device 9 comprises:
a first support 91 (PET of 125 μm, for example) with a first electrically conductive coating 92 (for example ITO) on the second face F2
an electroactive layer 93, based on liquid crystals in a polymer matrix (PDLC),
a second support 91′ (PET of 125 μm, for example) with a second electrically conductive coating (for example ITO) 92′ on the third face F3.

The peripheral electrically conductive coatings 92, 92′ are not covered by the electroactive layer 93 and are placed on current supply strips 90 for the electrical supply. In particular, the supports 91, 91′ protrude on two opposite sides.

For the purposes of protecting the layer 93, a chemical protection means 94 (barrier to the optional plasticizers in the PVB) may be provided, for example by adhesively-bonded or contacted PET polymer strips.

As a variant, the device is replaced by an electrochromic device or else a functional PET film (tinted, etc.).

Of course, all the configurations of location and arrangement for the reflective or transparent prismatic film or for a macroprism in face F4 already described in the previous figures can be used, in particular the (each) inverted reflective prismatic film (under or adjacent to the coated substrate).

FIG. 12 shows a schematic sectional view of an illuminable laminated sunroof 1200 for a motor vehicle according to the invention in a twelfth embodiment.

This roof 1200 differs from the preceding roof 1100 in that:
the exterior glass 1 is tinted, the upper intermediate layer 31 is optionally clear
the optical insulating coating 5 is on the front face 51′, then the film 5′ is chosen to be clear, and even protected by a protective layer 53 (for example similar to that described in FIG. 2)
a light source 4′ on the support 40′ thereof, and another reflective prismatic film 8′, are added

The reflective prismatic films are adhesively bonded to the coated substrate, as in FIG. 3.

Preferably, an IR-reflecting coating 17 is on the face F4.

Optionally, the scattering coating 6, for example a set of patterns of identical width, is not on the face F3 side or face F4 side but is printed on the face of the PVB 32 on the face F2 side, therefore is in local contact with the rear face 52′.

As a variant, the device 9 is replaced by an electrochromic device or else a tinted functional PET film, or else with an electrically conductive coating, in particular a solar control coating.

As a variant, the additional layer 33 is the size of the device 9 and of the coated substrate 5, 5′, and an intermediate frame layer is therefore added.

A single intermediate frame layer can be used, depending o the thickness thereof from the upper intermediate layer to the face F3.

FIG. 13 shows a schematic sectional view of an illuminable laminated sunroof 1300 for a motor vehicle according to the invention in a thirteenth embodiment.

This roof 1300 differs from the eleventh roof 1100 in that:
the optical insulating coating 5 is on the front face 51′, then the film 5′ is chosen to be clear,
the prismatic film is on the front face 51′, in adhesive contact with the additional layer 33.

FIG. 14 shows a schematic sectional view of an illuminable laminated sunroof 1400 for a motor vehicle according to the invention in a fourteenth embodiment.

This roof 1400 differs from the eleventh roof 1100 in that light is injected via the edge face 20 of the second sheet (the reflective prismatic film and the internal opaque element are eliminated).

Preferably, as a variant, the second sheet 2 is recessed from the first sheet 1 in order to house the light source 4, here, for example, with side emission.

Diodes 4 extend along the longitudinal coupling edge 20 of the second glass sheet 2. The PCB carrier 40 is attached for example by adhesive (or a double-sided adhesive) to the edge 20.

As a variant, the source 4 is housed in a hole of the second sheet 2.

FIG. 15 shows a schematic sectional view of an illuminable laminated sunroof 1500 for a motor vehicle according to the invention in a fifteenth embodiment.

This roof 1500 differs from the eleventh roof 1100 in that:
the frame layer 34 is opaque, black, forming an internal opaque element
the optical insulating coating 5 is protected by a protective layer 53
the internal edge 80′ of the prismatic film 8 (on the face F3) is under the edge face 50′ of the film 5′.

FIG. 16 shows a schematic sectional view of an illuminable laminated sunroof 1600 for a motor vehicle according to the invention in a sixteenth embodiment.

This roof 1600 differs from the eleventh roof 1100 in that:
the optical insulating coating 5 is on the front face 51′, in contact with the additional layer 33
the film 5 is thick, an intermediate frame layer 34 is added, clear, tinted or even opaque
a light source 4′ and a reflective prismatic film 8′ are added on the opposite edge side.

The reflective prismatic films are between the lower intermediate layer 32 and the frame layer 34.

Optionally, the scattering coating 6, for example a set of patterns of identical width, is not on the face F3 side or face F4 side but is printed on the face of the PVB 32 on the face F2 side.

Optionally, if required, an interior masking layer 71 is on the face F6 16 without interfering with the injection from the light source 4 (optionally locally reduced width).

FIG. 17 shows a schematic sectional view of an illuminable laminated sunroof 1700 for a motor vehicle according to the invention in a seventeenth embodiment.

This roof 1700 differs from the eleventh roof 1100 in that it comprises a third sheet 2′, made of mineral glass or polymer sheet (PC, PMMA), with a fifth main face F5 15, a sixth main face F6 16 and a third edge face 20′, having a refractive index n′1 preferably of at least 1.48 and at most 1.6, in particular from 1.5 to 1.53, which third sheet is bonded with the second sheet via another lamination interlayer 3′, 31′, 32′ comprising another upper intermediate layer 31′ and another lower intermediate layer 32′ in contact with the fifth face F5 and having a refractive index n′3 in the visible range.

The coated substrate 5′, 5 is then moved to be between the other upper and lower intermediate layers 31′, 32′ of said other lamination interlayer, for example made of PVB or TPU or crosslinked material, in particular crosslinked EVA.

n2 is then less than n′1, the difference in refractive indices n′1−n2 being at least 0.06 in the visible range.

Light is injected by the longitudinal (or lateral, as a variant) edge face 21′ of the third sheet (the reflective prismatic film and the internal opaque element are eliminated), which is recessed from the second sheet 2′, for example by at least 1 cm in order to house diodes (here with top or front emission) 4 plus the support 40.

The optical insulating coating 5 is on the front face 51′, in contact with the additional layer 33.

As a variant, the source 4 is housed in a hole of the third sheet.

The extraction means 6 are on face F6.

FIG. 18 shows a schematic sectional view of an illuminable laminated sunroof 1800 for a motor vehicle according to the invention in an eighteenth embodiment.

This roof 1800 differs from the preceding roof 1700 in that
a light source 4′ on the support 40′ thereof has been added, coupled to the opposite longitudinal edge 21 and the third sheet 2′ is then preferably also recessed from the second sheet 2
preferably, an IR-reflecting coating 17 is on face F6
the extraction means 6 are on face F5.

FIG. 19 shows a schematic sectional view of an illuminable laminated sunroof 1900 for a motor vehicle according to the invention in a nineteenth embodiment.

This roof 1900 differs from the eleventh roof 1100 in that the device is replaced by a photovoltaic device 9′ with one or more solar cells.

Preferably, the upper intermediate layer 31 is clear, for example PVB, and the exterior glass 1 is clear.

Of course, all the configurations of location and arrangement for the reflective or transparent prismatic film or for a macroprism in face F4 already described in the previous figures can be used, in particular the (each) inverted reflective prismatic film (under or adjacent to the coated substrate).

1. An illuminable laminated sunroof for a vehicle, comprising:
a laminated glazed unit including:
a first transparent sheet made of mineral glass, with a first main face, a second, opposing, main face and a first edge face, intended to form an exterior glass,
a polymer lamination interlayer comprising an upper intermediate layer, in adhesive contact with the second main face or with a functional transparent coating on the second main face,
a second transparent sheet made of mineral glass or polymer, with a third main face, a fourth, opposing, main face and a second edge face,
a transparent optical insulating layer, having a refractive index n2 in the visible range, which optical insulating layer is of submillimetric thickness and at least 400 nm,
a coated substrate that comprises:
a transparent film, made of material different from a fluoropolymer, with a front main face oriented toward the second main face and an opposing rear main face of submillimetric thickness,
the optical insulating layer, which is an optical insulating coating, made of material comprising a matrix different from a fluoropolymer, on one of the front main face or the rear main face forming a coated face, and an edge face,
and wherein:
in a first configuration i), the first transparent sheet and/or the upper intermediate layer being tinted, the second sheet has a refractive index n1, the coated substrate is laminated between the second and third main faces, and is between the upper intermediate layer and a lower intermediate layer of refractive index n3 in the visible range, in adhesive contact with the third main face or with a functional transparent coating on the third main face, n2 is less than n1, a difference in refractive indices n1−n2 being at least 0.06 in the visible range
or in a second configuration j), the illuminable laminated sunroof comprises a third sheet, made of mineral glass or polymer sheet, with a fifth main face, a sixth main face and a third edge face, having a refractive index n′1, which third sheet is bonded with the second sheet via another lamination interlayer comprising another upper intermediate layer and another lower intermediate layer in contact with the fifth main face and having a refractive index in the visible range, the coated substrate is between the other upper and lower intermediate layers of said other lamination interlayer,
at least one element being tinted from the first transparent sheet, intermediate layer of the lamination interlayer, the second transparent sheet, the other upper intermediate layer,
n2 is less than n′1, a difference in refractive indices n′1−n2 being at least 0.06 in the visible range.

2. The illuminable laminated glazed vehicle roof according to claim 1, wherein the difference in refractive indices n1−n2 or n′1−n2 is at least 0.08 in the visible range and wherein the thickness of the optical insulating layer is at least 500 nm.

3. The illuminable laminated glazed vehicle roof according to claim 1, wherein the optical insulating coating is on the rear face.

4. The illuminable laminated glazed vehicle roof according to claim 1, wherein the optical insulating coating is on the front main face.

5. The illuminable laminated glazed vehicle roof according to claim 1, wherein the lamination interlayer or the other lamination interlayer is in adhesive contact with the coated substrate on the coated face side and on the face opposite the coated face, and optionally a functional coating is on the thermoplastic lower intermediate layer or the other thermoplastic lower intermediate layer is in contact with the rear face or with the optical insulating coating.

6. The illuminable laminated glazed vehicle roof according to claim 1, wherein the optical insulating coating comprises a crosslinked polymer matrix having said index n2.

7. The illuminable laminated glazed vehicle roof according to claim 1, wherein the optical insulating coating comprises a matrix having a refractive index n2ₘ greater than n2 and less than n1 or n′1, and comprising (nano)porosities and/or (nano)particles of low index, having a refractive index of less than n1 or than n′1 with a size of at most 300 nm.

8. The illuminable laminated glazed vehicle roof according to claim 7, wherein the matrix is organic, or the matrix is mineral.

9. The illuminable laminated glazed vehicle roof according to claim 1, comprising a transparent protective layer having a refractive index greater than n2, of submillimetric thickness covering the optical insulating coating, which transparent protective layer is:
in contact with the lower intermediate layer or the other lower intermediate layer,
or in contact with the upper intermediate layer or the other upper intermediate layer, the optical insulating coating being on the front face.

10. The illuminable laminated glazed vehicle roof according to claim 1, wherein the transparent film is recessed from the first or second edge face by at least 10 mm and the roof comprises an intermediate frame layer, surrounding a periphery of the coated substrate.

11. The illuminable laminated glazed vehicle roof according to claim 1, wherein the transparent film is a thermoplastic polymer or crosslinked polymer.

12. The illuminable laminated glazed vehicle roof according to claim 1, comprising a light source optically coupled to a light guide arranged under the optical insulating coating, farther from the second main face than the optical insulating coating.

13. The illuminable laminated glazed vehicle roof according to claim 1, comprising, under the optical insulating coating, farther from the second main face than the optical insulating coating, light extraction means, comprising a scattering coating, with a binder and scattering particles,
in the first configuration i), the lower intermediate layer or the second sheet is the substrate of the scattering coating,
in the second configuration j), the other lower intermediate layer or the third sheet is the substrate of the scattering coating, thus on the fifth or sixth main face, or on the rear face side.

14. The illuminable laminated glazed vehicle roof according to claim 13, wherein the binder of the scattering coating is organic.

15. The illuminable laminated glazed vehicle roof according to claim 14, wherein the binder of the scattering coating is a polyacrylate polymer, and the binder of the optical insulating coating is a polyacrylate polymer.

16. The illuminable laminated sunroof for a vehicle according to claim 1, wherein, in the first configuration i), the illuminable laminated sunroof comprises, on the fourth main face side, a light source and a light redirecting element that is reflective and is on the third main face, or the transparent light redirecting element, on the fourth main face side.

17. The illuminable laminated sunroof for a vehicle according to claim 1, comprising, in the first configuration i), a light source on the fourth main face side, and a light-redirecting element comprising reflective prisms,
and wherein the light redirecting element is:
at least partially facing the optical insulating coating
or at most 4 mm away from the optical insulating coating.

18. The illuminable laminated sunroof for a vehicle according to claim 16, wherein the light-redirecting element is a reflective prismatic element, comprising reflective prisms arranged on the third main face side, is:
on the third main face,
in the lamination interlayer:
embedded in the lower intermediate layer or in an intermediate frame layer on the periphery of the coated film,
on the lower intermediate layer, between the lower intermediate layer and the clear or tinted upper intermediate layer or an intermediate frame layer on the periphery of the clear,
on the front main face or rear main face.

19. The illuminable laminated glazed vehicle roof according to claim 1, comprising, between the upper intermediate layer and the lower intermediate layer, above said optical insulating coating, an electrically controllable device comprising an electroactive layer between a front electrically conductive support on the second main face side and a rear electrically conductive support on the third main face side, or a photovoltaic device, the coated substrate being sandwiched between the additional intermediate layer and the lower intermediate layer.

20. The illuminable laminated glass roof for vehicle according to claim 1, comprising at least one of the following functional elements:
an internal opaque peripheral masking layer, between the second main face and the third main face,
an interior opaque peripheral masking layer on the fourth main face or the sixth main face,
an internal opaque peripheral element which is between the second main face and the third main face,
an internal electroconductive coating on the second main face on the first transparent sheet, or on an additional film,
an external electroconductive coating on the fourth main face of the second transparent sheet made of mineral glass in the first configuration i), or on the sixth main face of the second transparent sheet made of mineral glass in the second configuration j).

21. A vehicle comprising at least one illuminable laminated sunroof according to claim 1.
